(19) United States
(12) Patent Application Publication
(10) Pub. No.: US 2011/0233133 A1
(43) Pub. Date: Sep. 29, 2011

(54) Direct Flow Filter Including an Integrated Flexible Seal

(75) Inventors: John W. Wacker, Evansville, WI (US); Daniel R. Cady, Janesville, WI (US); Clint A. Myers, Stoughton, WI (US)

(73) Assignee: Cummins Filtration IP, Inc., Minneapolis, MN (US)

(21) Appl. No.: 12/183,502

(22) Filed: Jul. 31, 2008

(51) Int. Cl. B01D 29/07

(52) U.S. Cl. 210/487; 210/493.1

(57) ABSTRACT

A direct flow filter has a first portion and second portion that are flexibly coupled along a joint that comprises a flexible sealing strip.

The invention relates to filters, and more particularly to direct flow filters. Related technology is disclosed in patent documents that include U.S. Pat. Nos. 7,314,558 and 7,323,106; U.S. publication nos. 2006/0065592, 2008/0011672, and 2008/0011673; and international publication nos. WO2008/0067029 and WO2008/067030, the contents of which are incorporated herein by reference in their entireties.

### BACKGROUND AND SUMMARY

The invention arose during continuing development efforts directed toward improved filter performance, construction, and cost efficiency, while maintaining a high media utilization coefficient.

### BRIEF DESCRIPTION OF THE DRAWINGS

### Prior Art

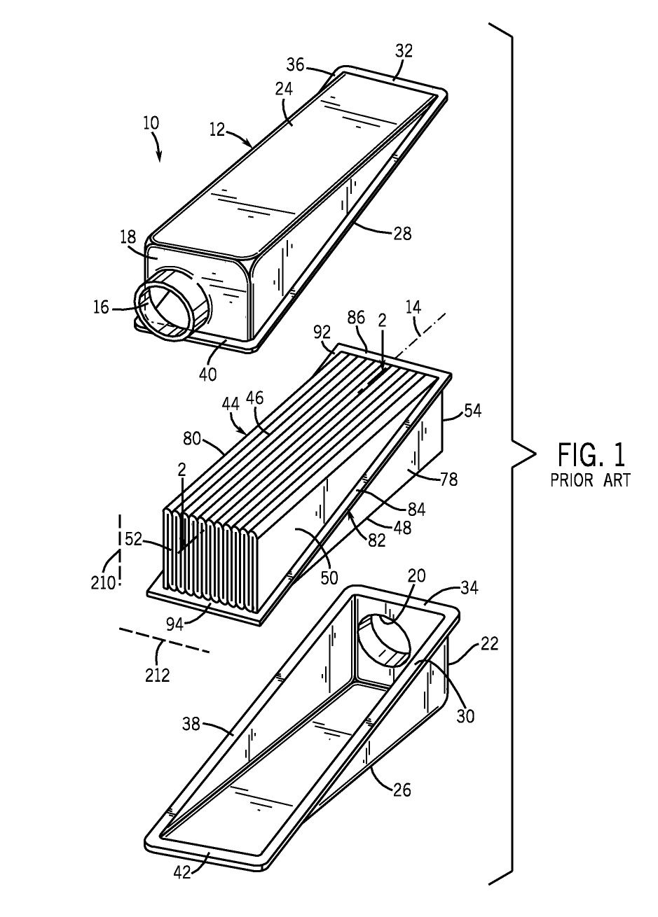

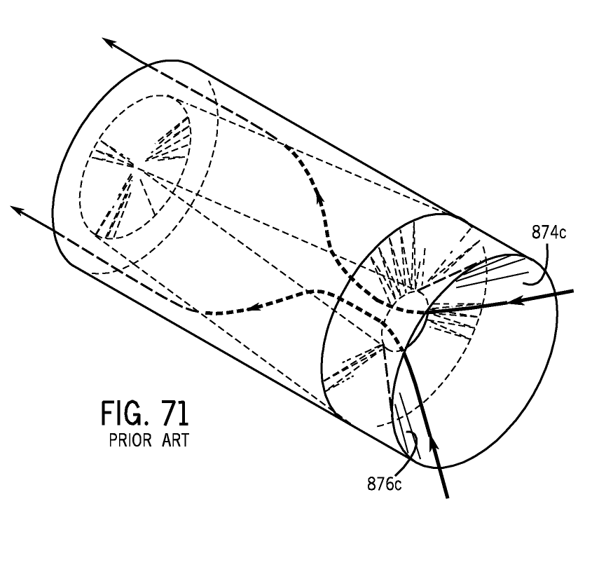

FIGS. 1-71 are taken from the above noted U.S. publication no. 2008/0011673, which is incorporated herein by reference.

FIG. 1 is an exploded perspective view of a filter.

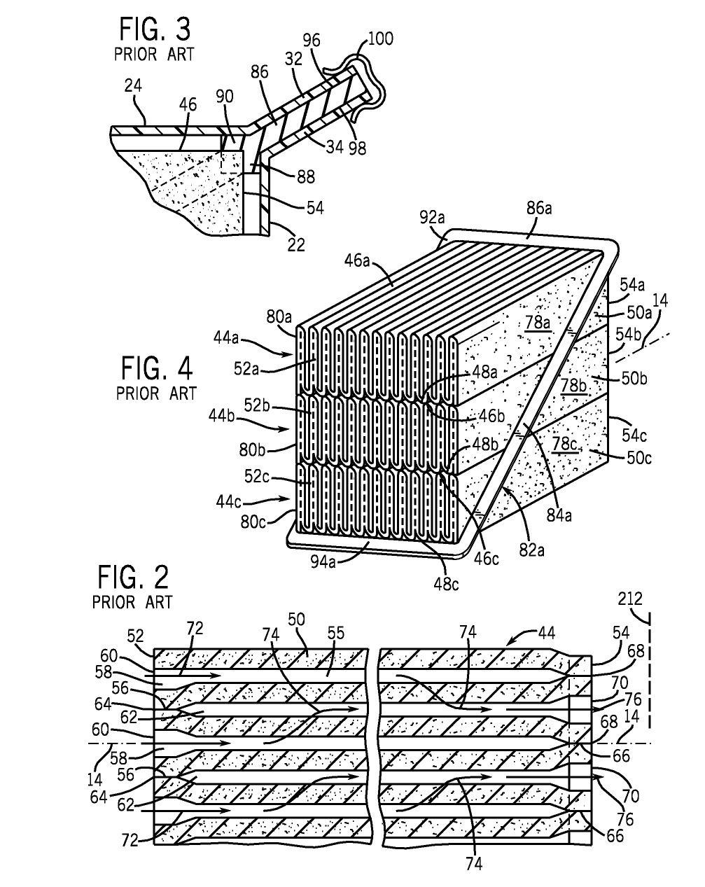

FIG. 2 is a sectional view taken along line 2-2 of FIG. 1.

FIG. 3 is a sectional view of a portion of the filter of FIG. 1 in assembled condition.

FIG. 4 is a perspective view similar to a portion of FIG. 1 and shows an alternate embodiment.

FIG. 5 is an exploded perspective view of an alternate embodiment.

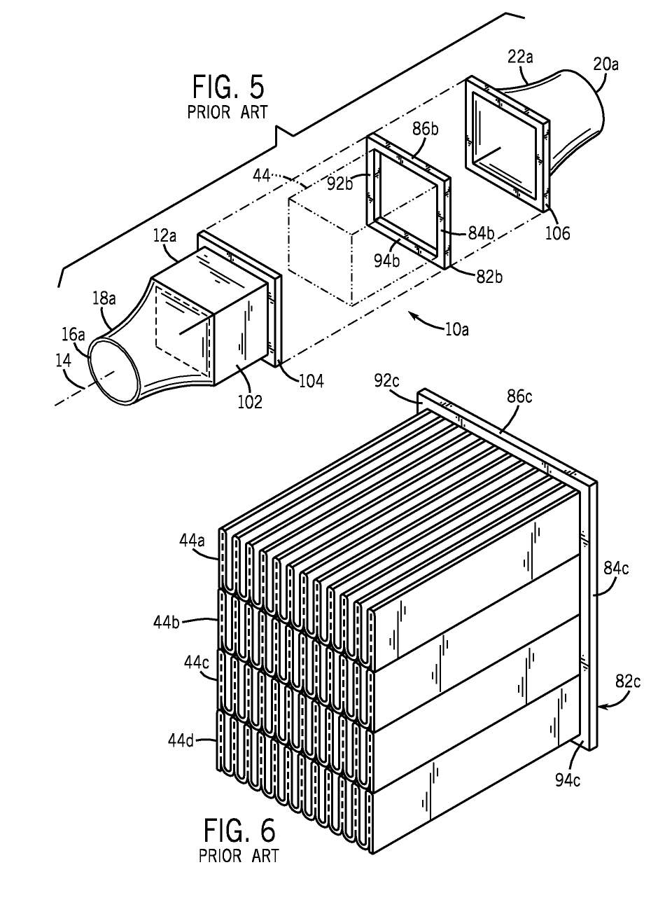

FIG. 6 is like FIG. 4 and shows another embodiment.

FIG. 7 is similar to FIG. 6 and illustrates sealing between elements.

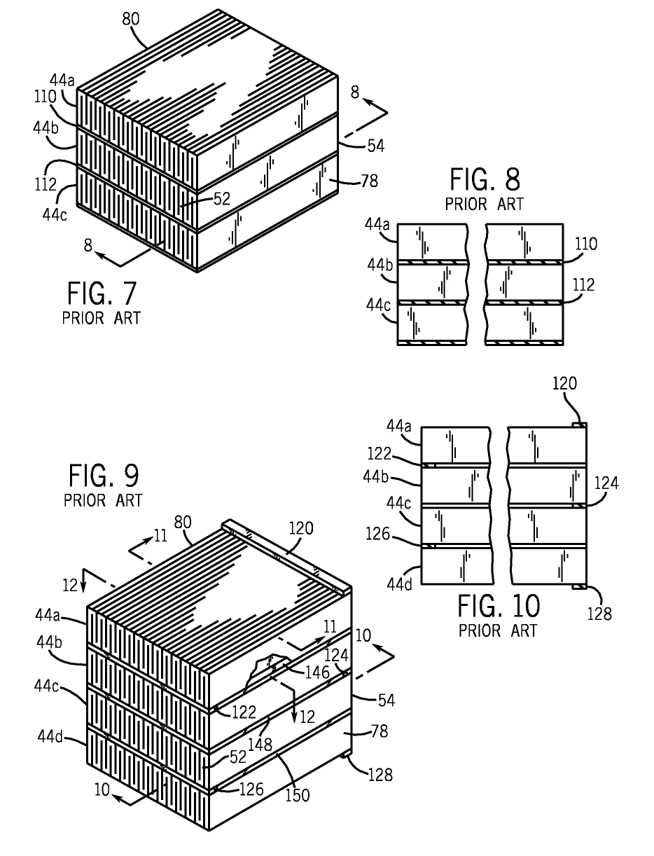

FIG. 8 is a sectional view taken along line 8-8 of FIG. 7.

FIG. 9 is like FIG. 7 and shows another embodiment.

FIG. 10 is a sectional view taken along line 10-10 of FIG. 9.

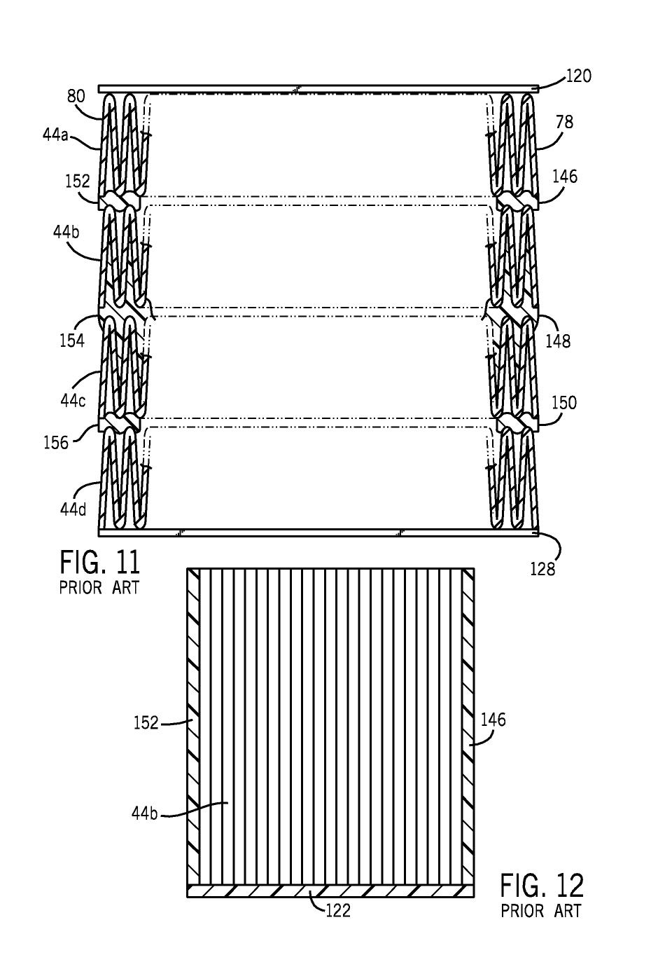

FIG. 11 is a sectional view taken along line 11-11 of FIG. 9.

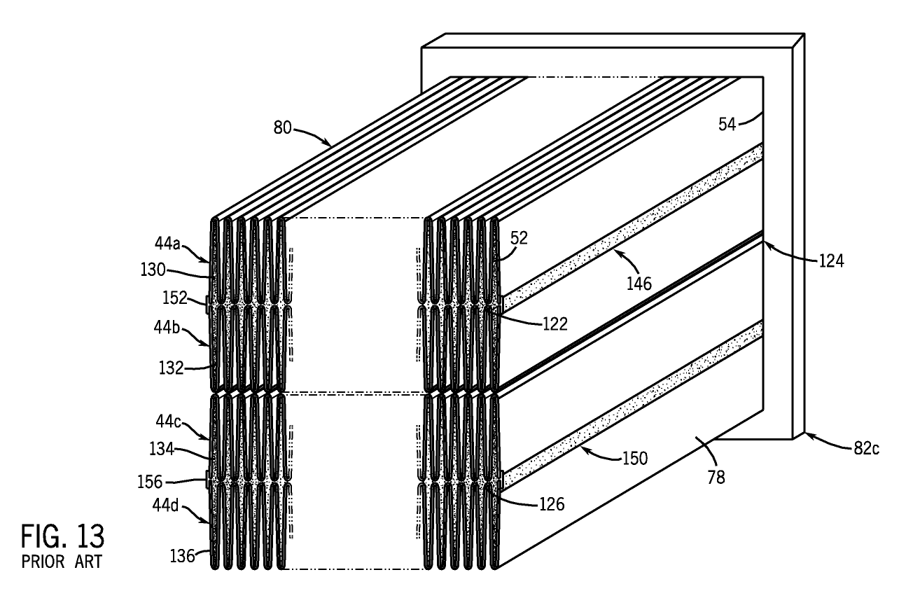

FIG. 12 is a sectional view taken along line 12-12 of FIG. 9.

FIG. 13 is similar to FIGS. 4, 6, 7, 9, and further illustrates sealing.

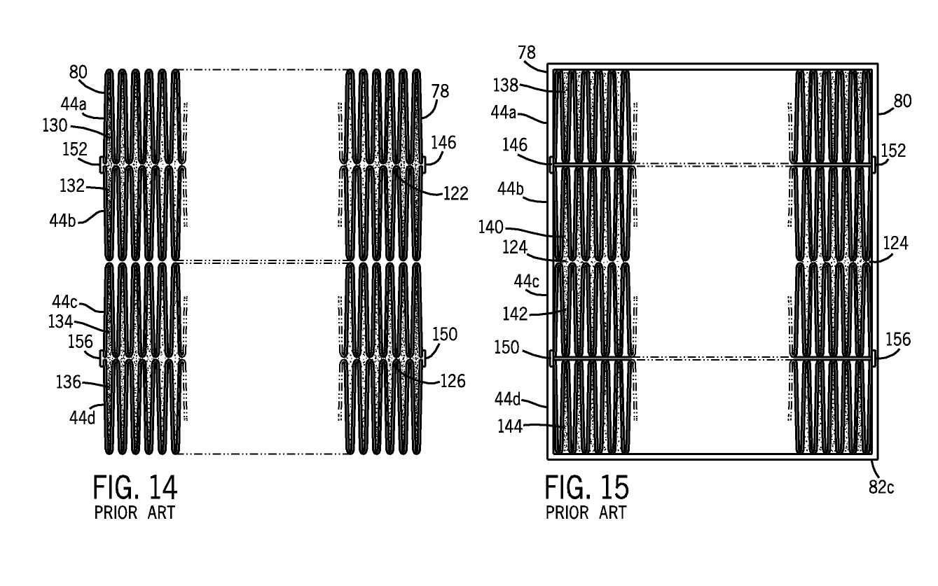

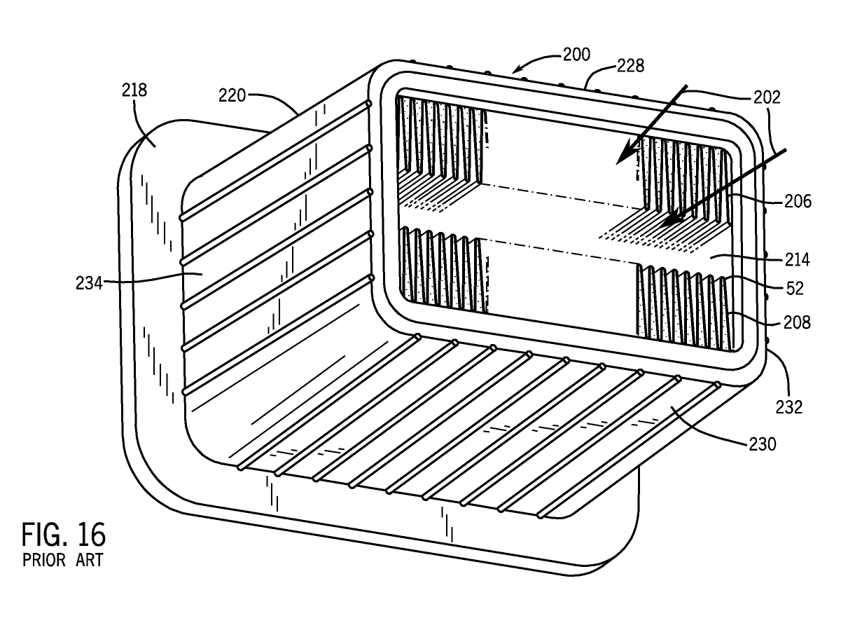

FIG. 14 is an elevational view of the front or upstream side of the filter of FIG. 13.

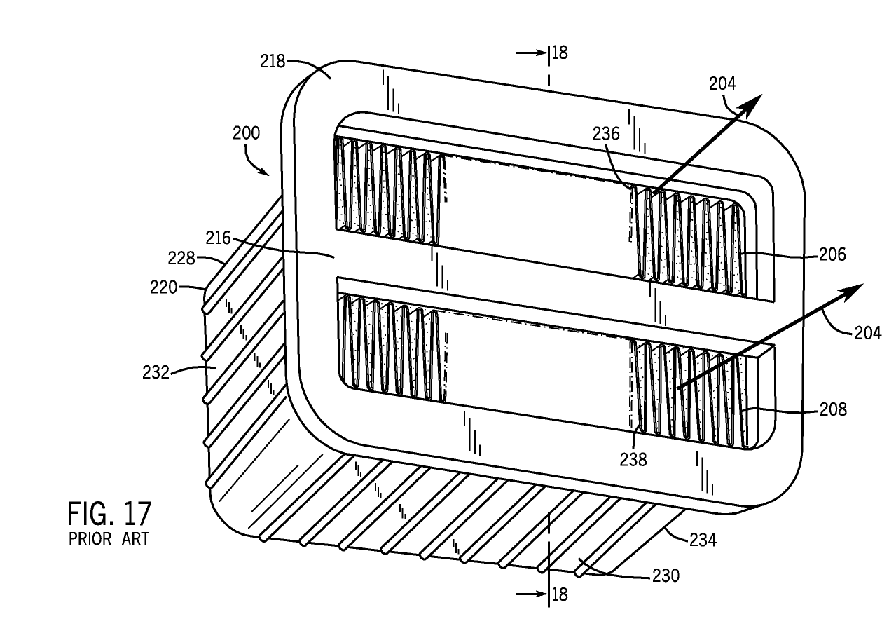

FIG. 15 is an elevational view of the back or downstream side of the filter of FIG. 13.

FIG. 16 is a perspective view showing the inlet end of a filter.

FIG. 17 is a perspective view showing the outlet end of the filter of FIG. 16.

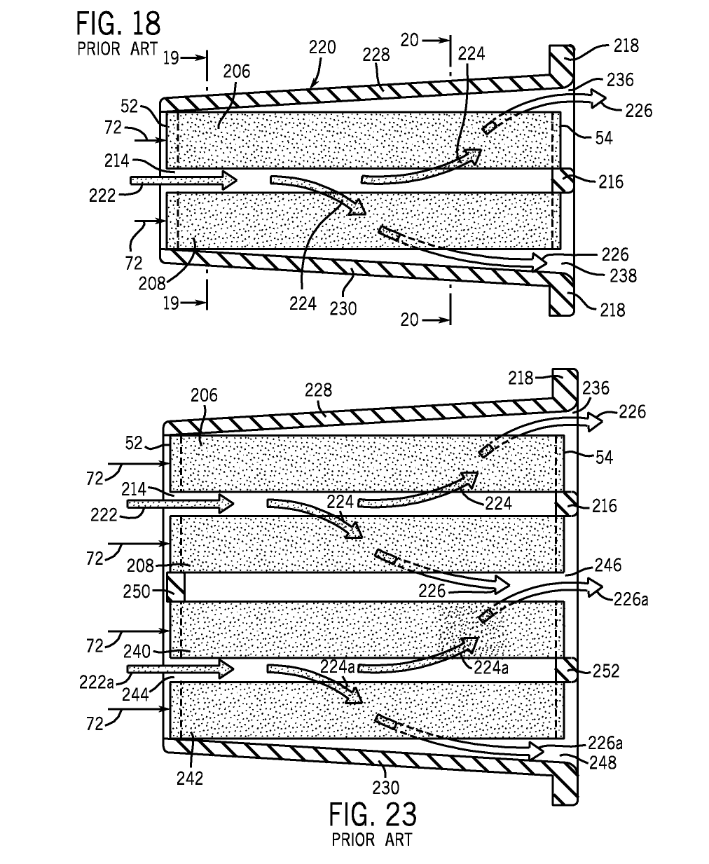

FIG. 18 is a sectional view taken along line 18-18 of FIG. 17.

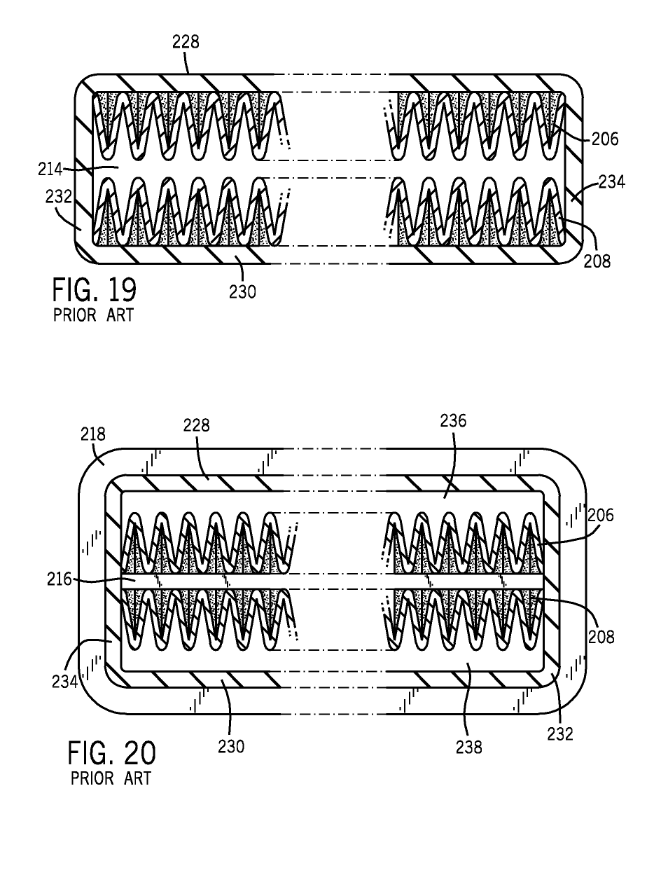

FIG. 19 is a sectional view taken along line 19-19 of FIG. 18.

FIG. 20 is a sectional view taken along line 20-20 of FIG. 18.

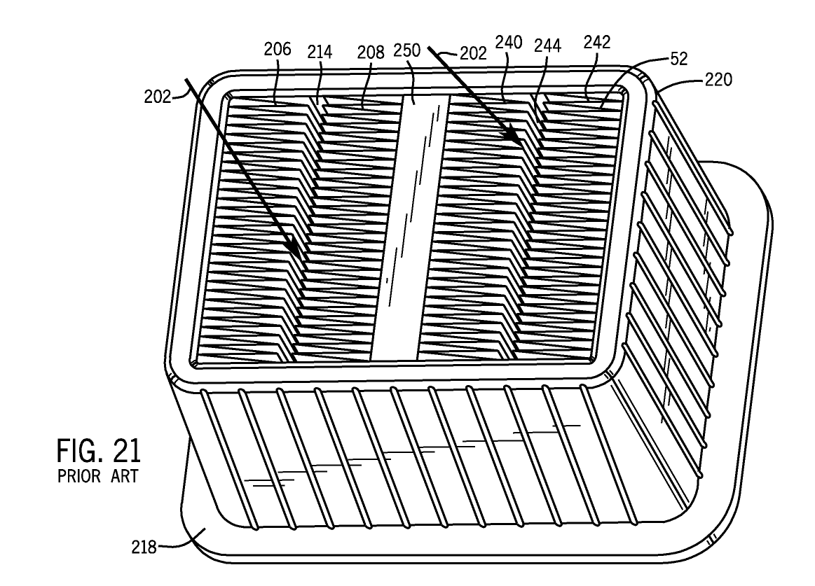

FIG. 21 is a perspective view showing the inlet end of an alternate embodiment of a filter.

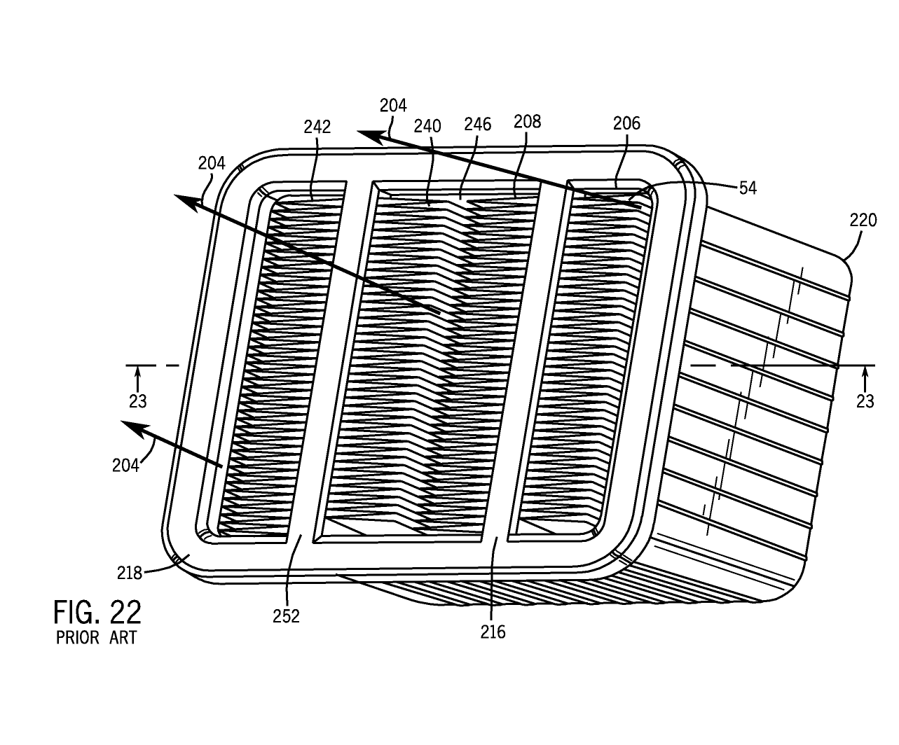

FIG. 22 is a perspective view showing the outlet end of the filter of FIG. 21.

FIG. 23 is a sectional view taken along line 23-23 of FIG. 22.

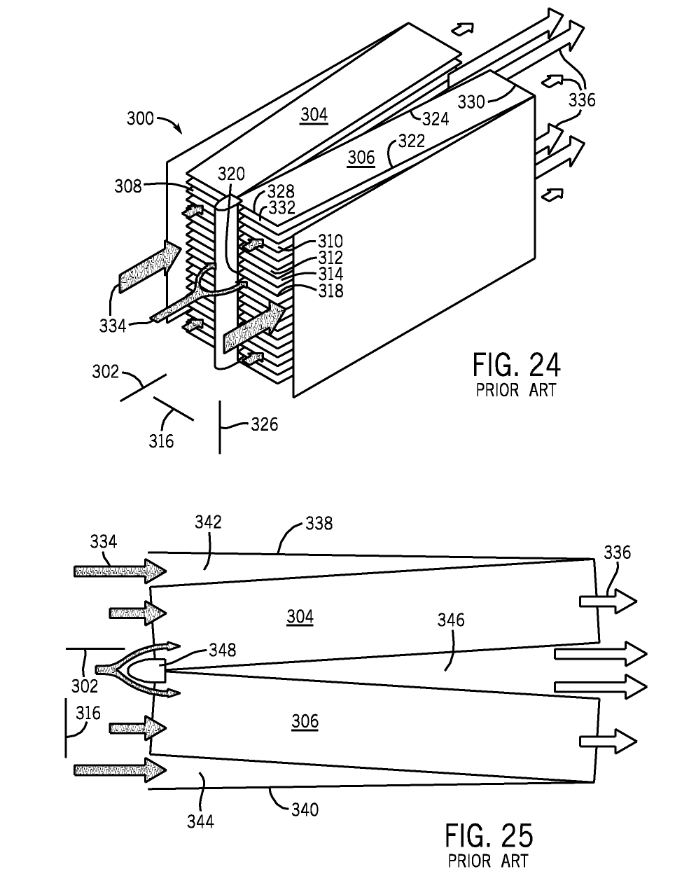

FIG. 24 is a perspective view of a filter in accordance with the parent '934 application.

FIG. 25 is a top elevation view of the filter of FIG. 24.

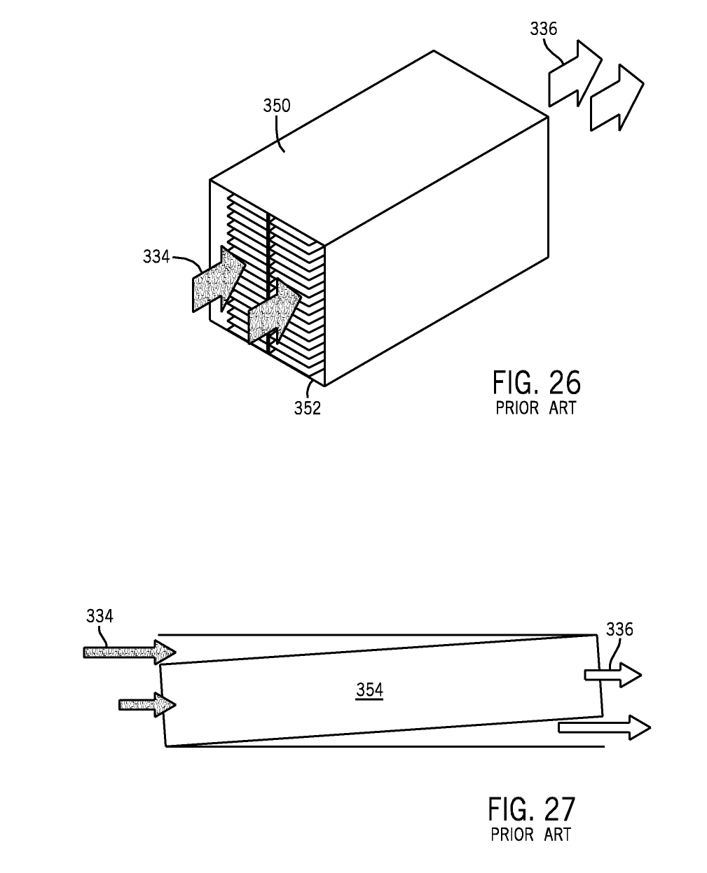

FIG. 26 is a perspective view like that in FIG. 24.

FIG. 27 is a top elevation view of a further embodiment.

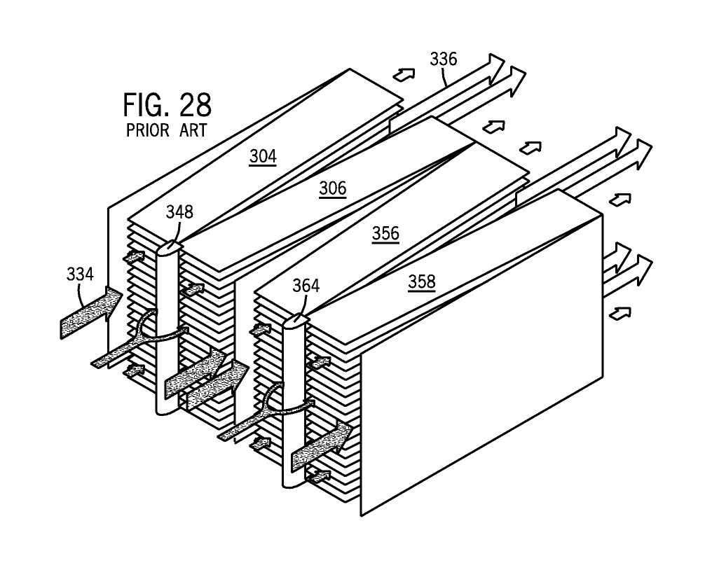

FIG. 28 is like FIG. 24 and shows another embodiment.

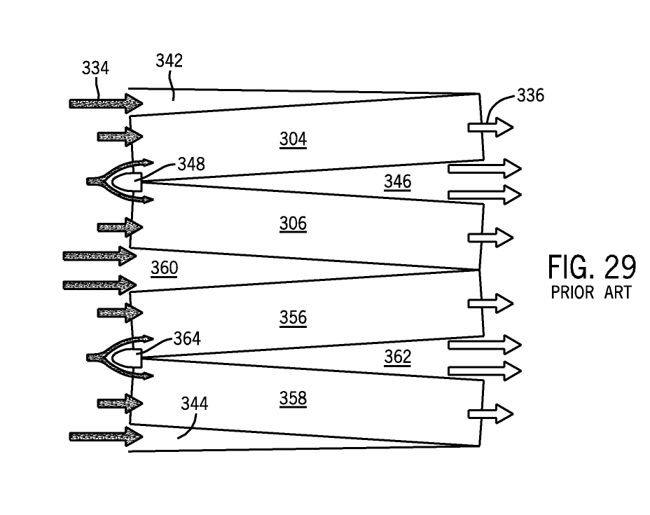

FIG. 29 is a top elevation view of the filter of FIG. 28.

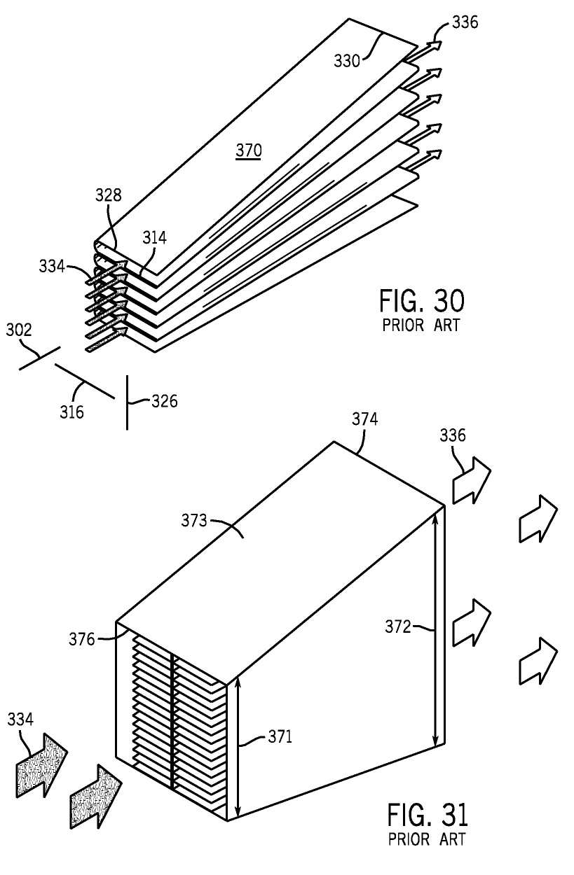

FIG. 30 is a perspective view of a filter element showing a further embodiment.

FIG. 31 is like FIG. 30 and shows a further embodiment.

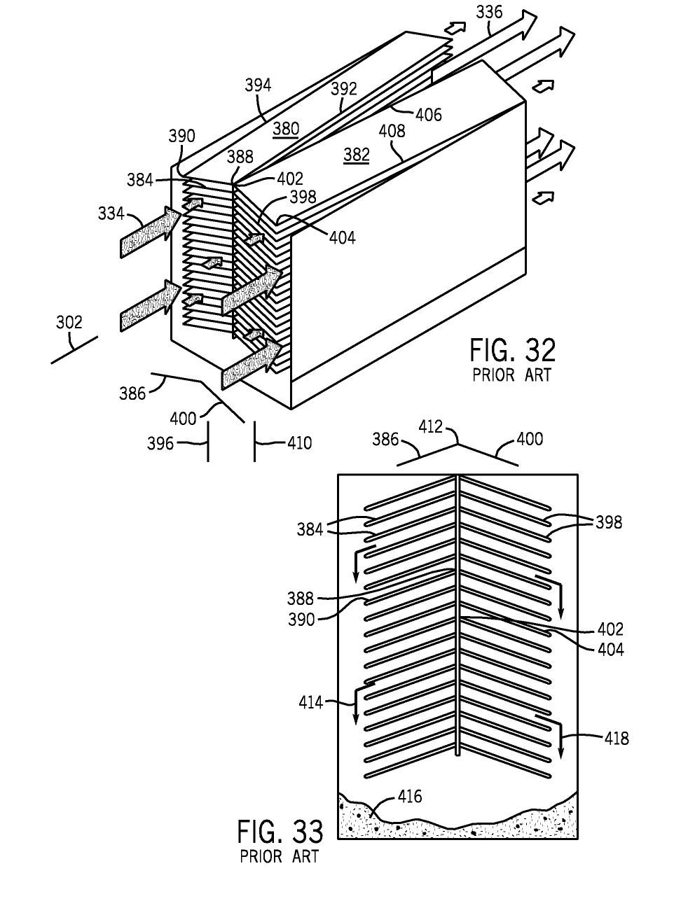

FIG. 32 is a perspective view like FIG. 24 and shows another embodiment.

FIG. 33 is a front elevation view showing the filter of FIG. 32.

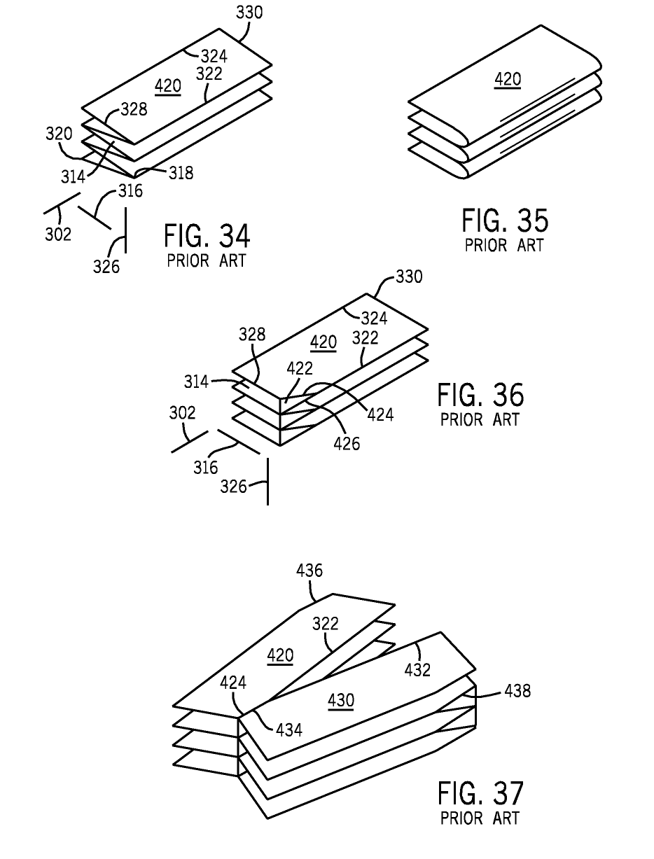

FIG. 34 is a perspective view like FIG. 24 and shows a further embodiment.

FIG. 35 is like FIG. 34 and further shows the filter element.

FIG. 36 is like FIG. 34 and shows a further embodiment.

FIG. 37 is like FIG. 36 and shows a further embodiment.

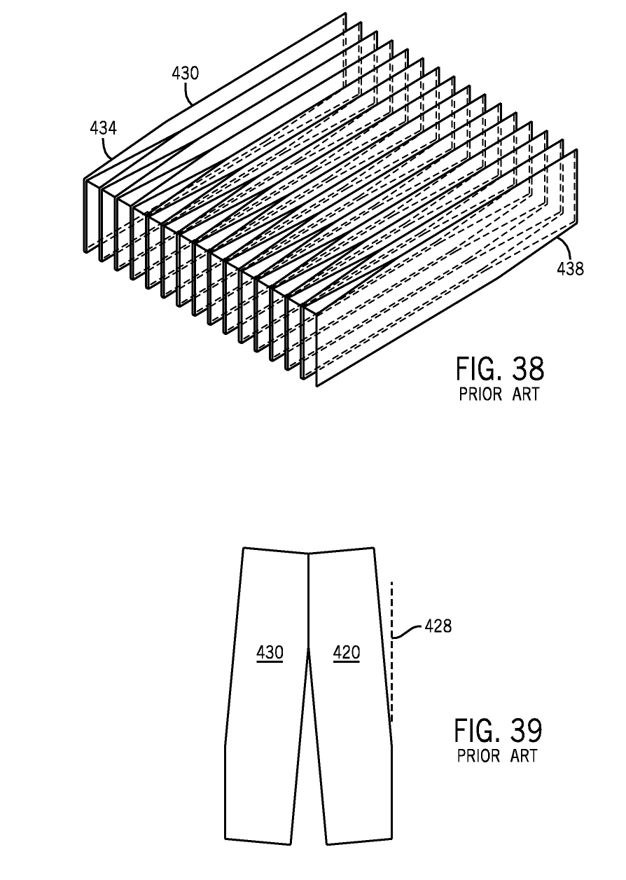

FIG. 38 is like FIG. 36 and shows a further embodiment.

FIG. 39 is a top elevation view of the filter of FIG. 37.

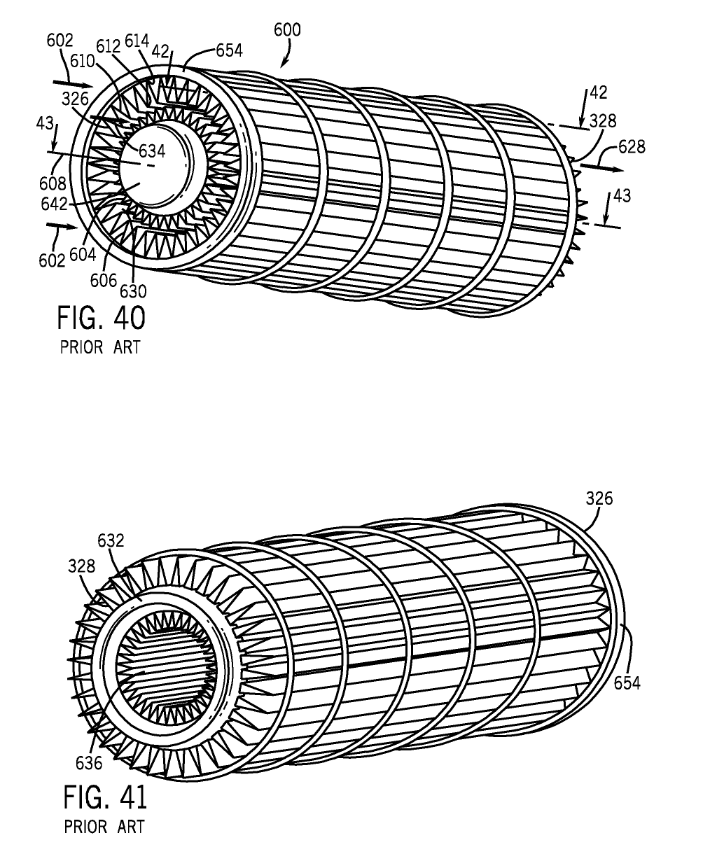

FIGS. 40-47 are taken from FIGS. 28-35, respectively, of U.S. Pat. No. 6,511,599, incorporated herein by reference.

FIG. 40 is a perspective view showing the inlet end of a filter.

FIG. 41 is a perspective view showing the outlet end of the filter of FIG. 40.

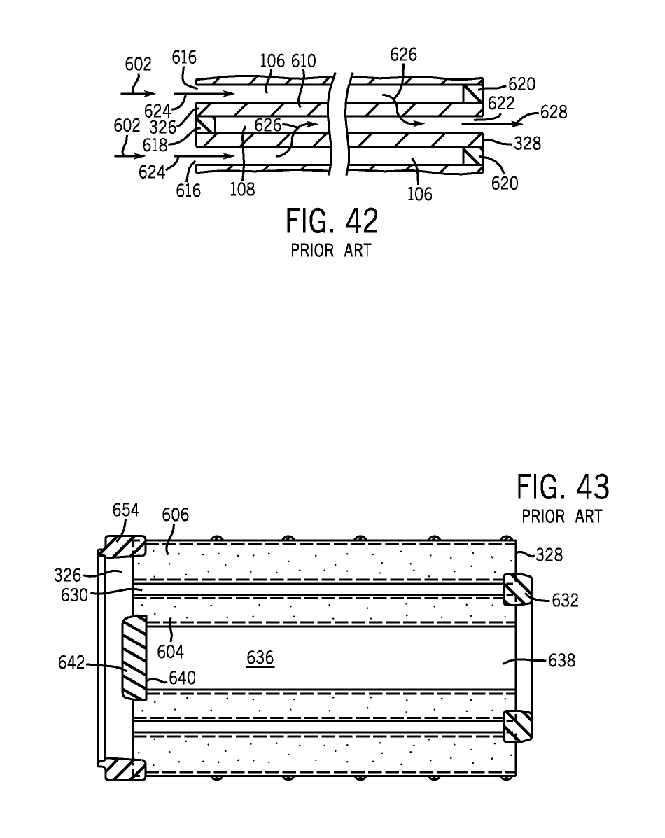

FIG. 42 is a sectional view taken along line 42-42 of FIG. 40.

FIG. 43 is a sectional view taken along line 43-43 of FIG. 40.

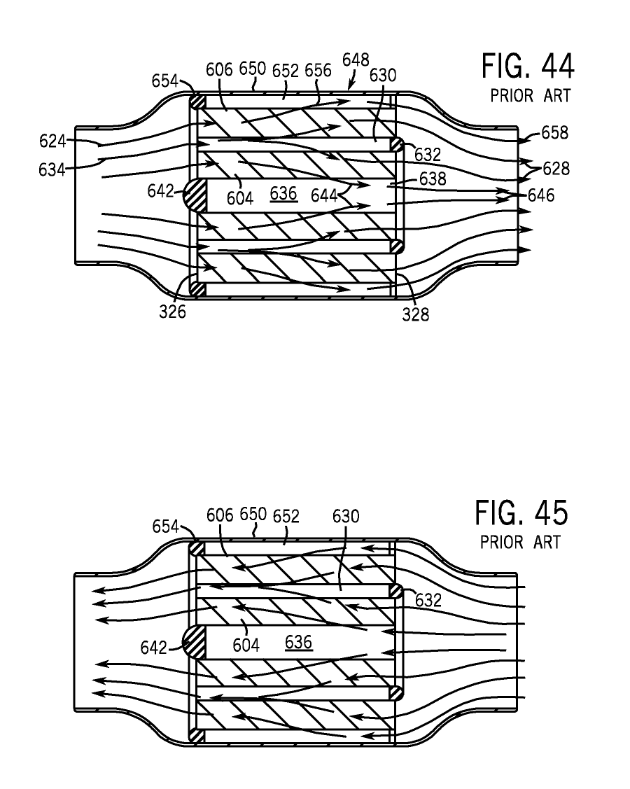

FIG. 44 is a view like FIG. 43 and also shows the filter housing.

FIG. 45 is like FIG. 44 and shows opposite direction flow.

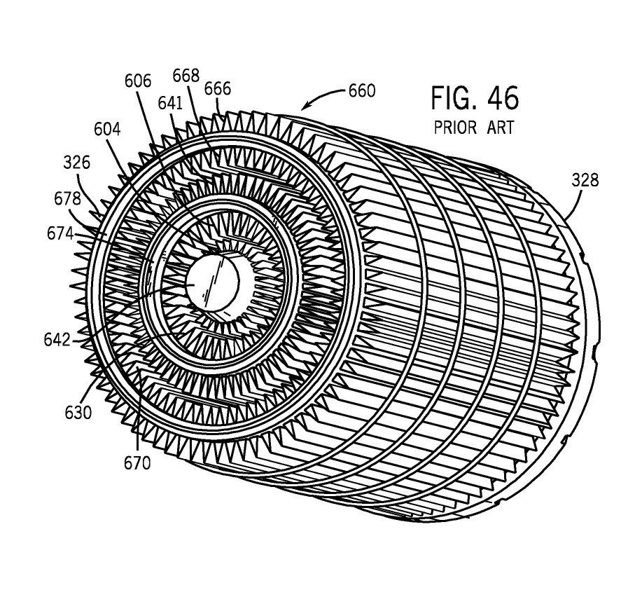

FIG. 46 is a perspective view showing the inlet end of another embodiment of a filter.

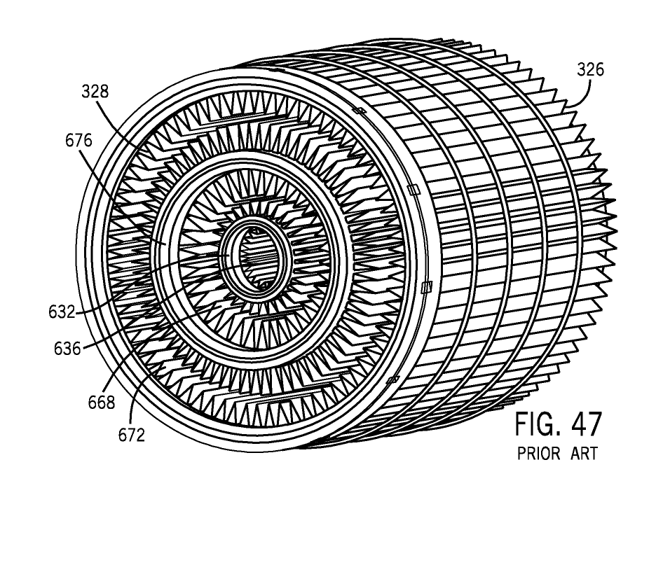

FIG. 47 is a perspective view showing the outlet end of the filter of FIG. 46.

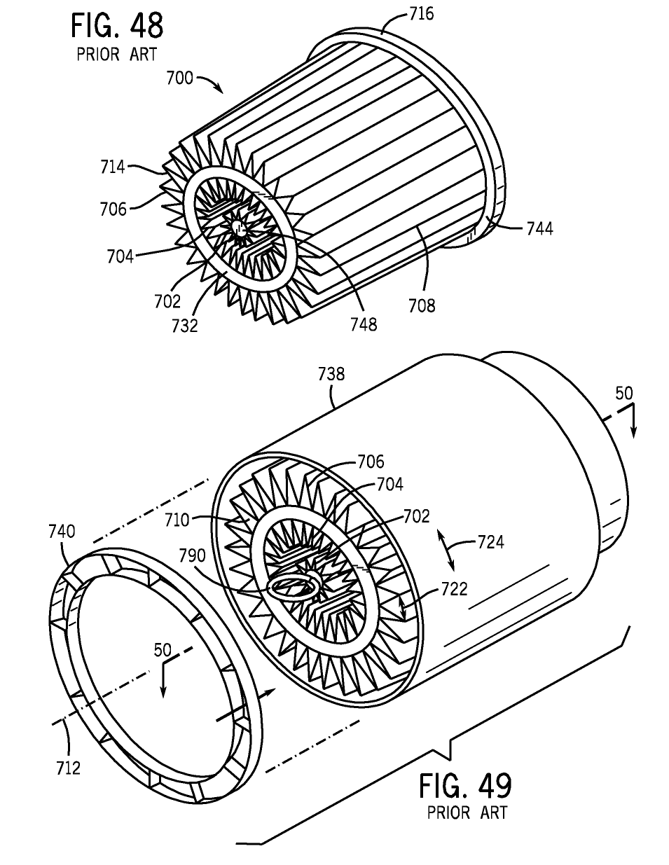

FIG. 48 is a perspective view of a filter in accordance with the parent '619 application.

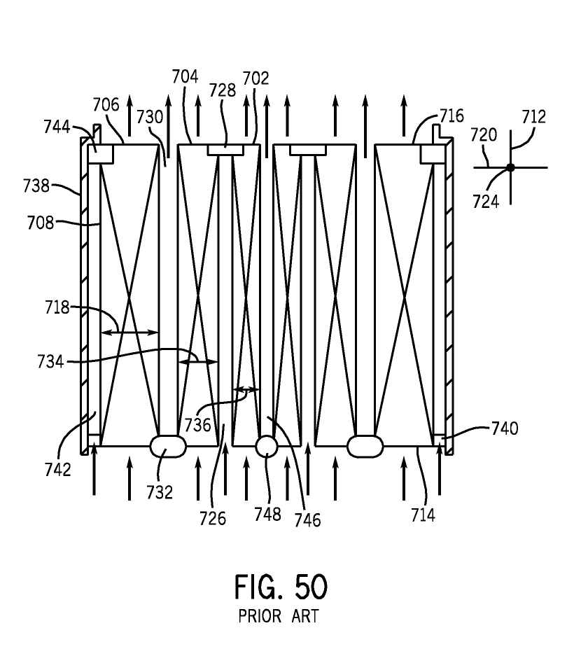

FIG. 49 is an exploded perspective view of the filter of FIG. 48 housed in a housing.
FIG. 50 is a sectional view taken along line 50-50 of FIG. 49.

FIG. 51 is like FIG. 50 and shows reverse flow.

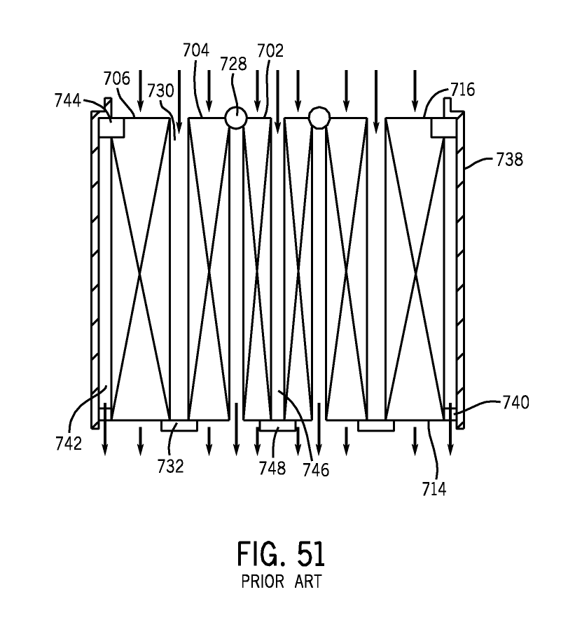

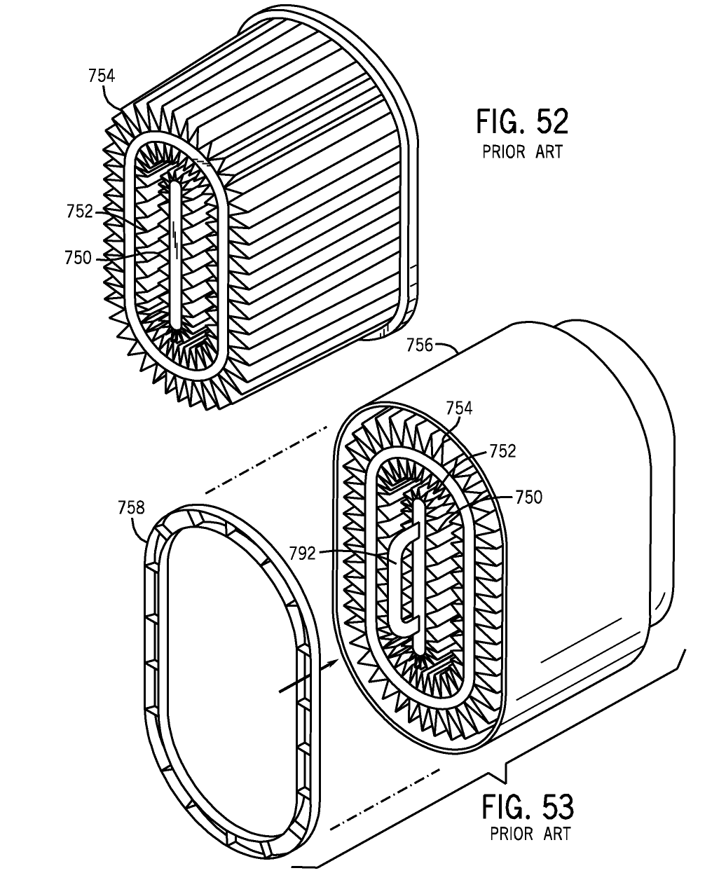

FIG. 52 is like FIG. 48 and shows another embodiment.

FIG. 53 is like FIG. 49 and shows the embodiment of FIG. 52.

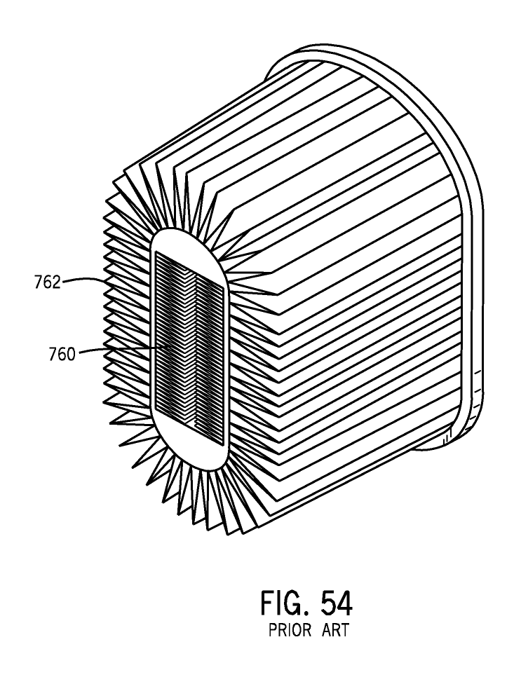

FIG. 54 is like FIG. 52 and shows another embodiment.

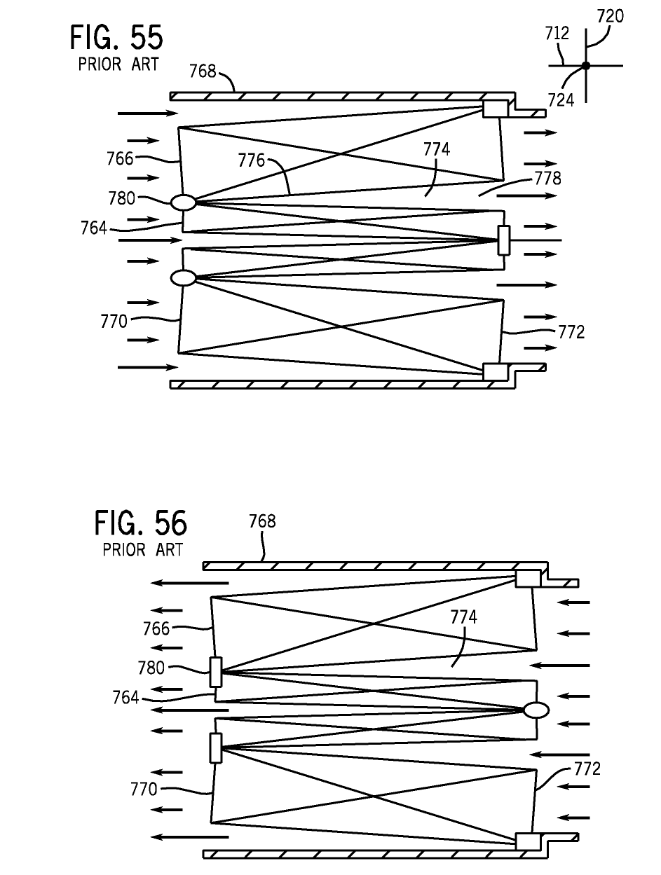

FIG. 55 is like FIG. 50 and shows another embodiment.

FIG. 56 is like FIG. 55 and shows reverse flow.

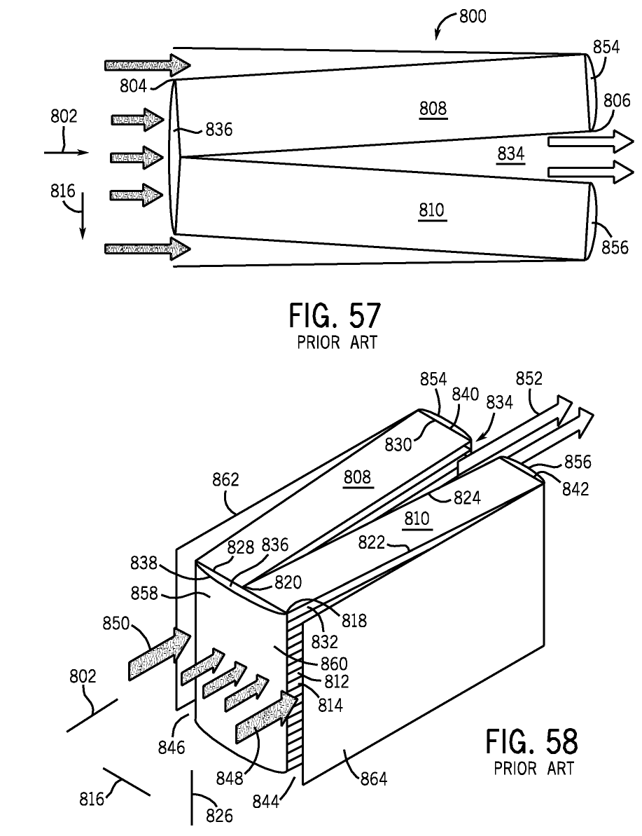

FIG. 57 is like FIG. 25 and shows the present invention.

FIG. 58 is a perspective view of the filter of FIG. 57, including the inlet end.

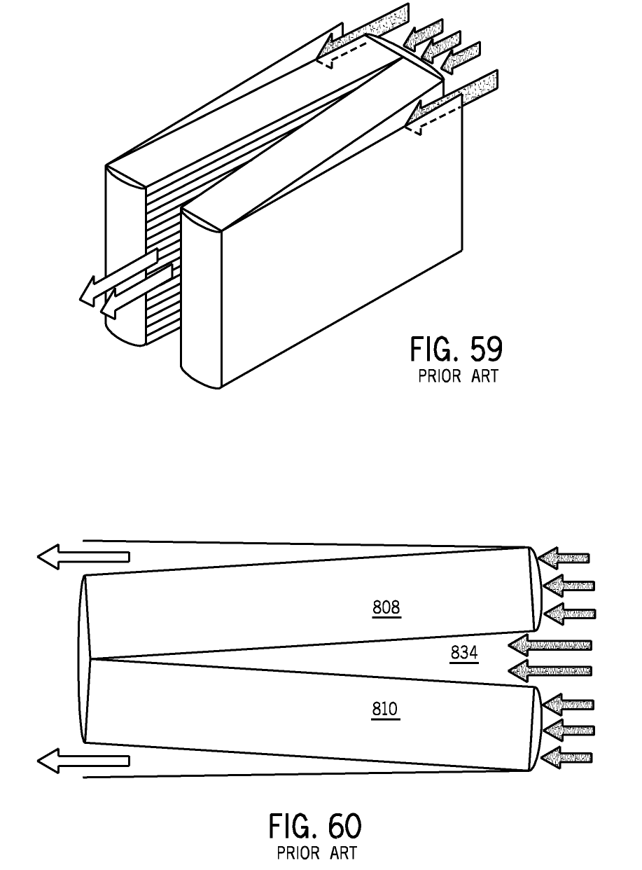

FIG. 59 is another perspective view of the filter of FIG. 57, including the outlet end.

FIG. 60 is like FIG. 57 and shows reverse flow.

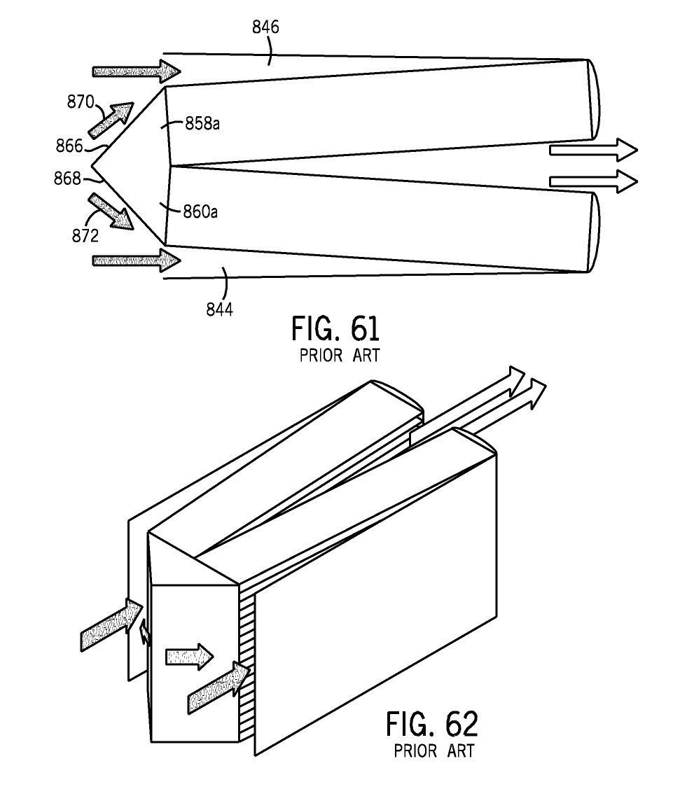

FIG. 61 is like FIG. 57 and shows another embodiment.

FIG. 62 is a perspective view of the filter of FIG. 61, showing the inlet end.

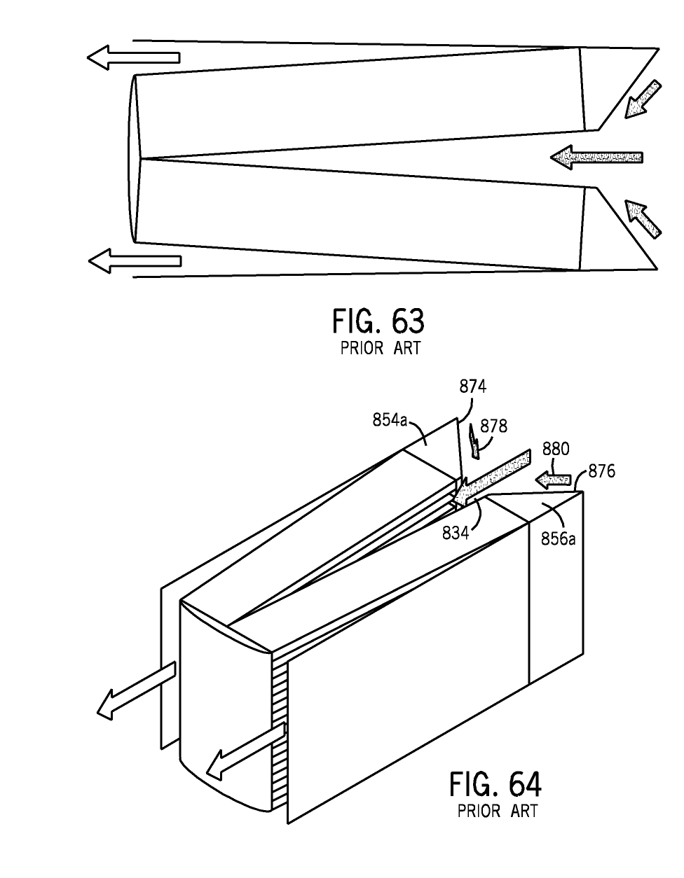

FIG. 63 is like FIG. 60 and shows another embodiment.

FIG. 64 is a perspective view of the filter of FIG. 63.

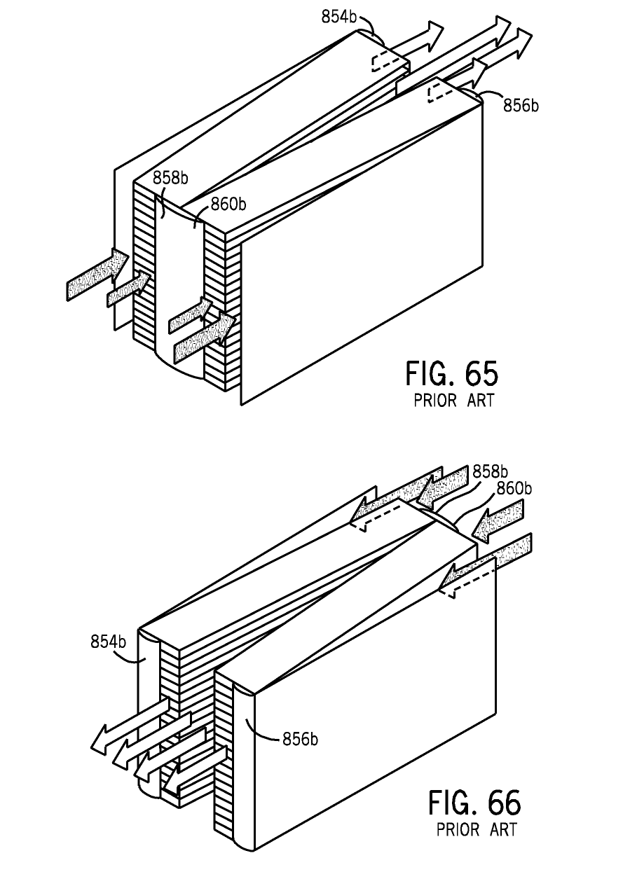

FIG. 65 is like FIG. 58 and shows another embodiment.

FIG. 66 is like FIG. 59 and shows another embodiment.

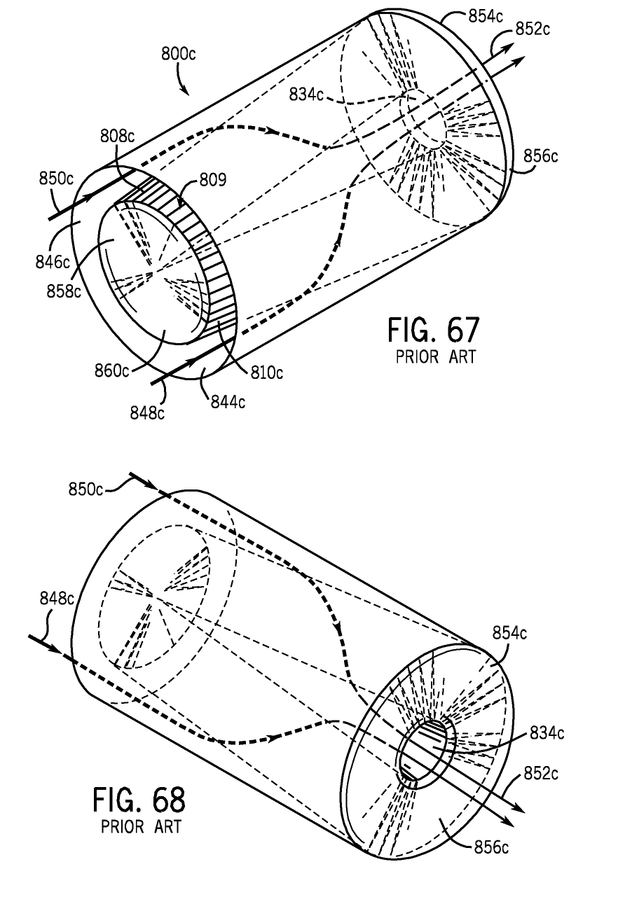

FIG. 67 is a perspective view of another embodiment of a filter in accordance with the invention, showing the inlet end.

FIG. 68 is a perspective view of the filter of FIG. 67, showing the outlet end.

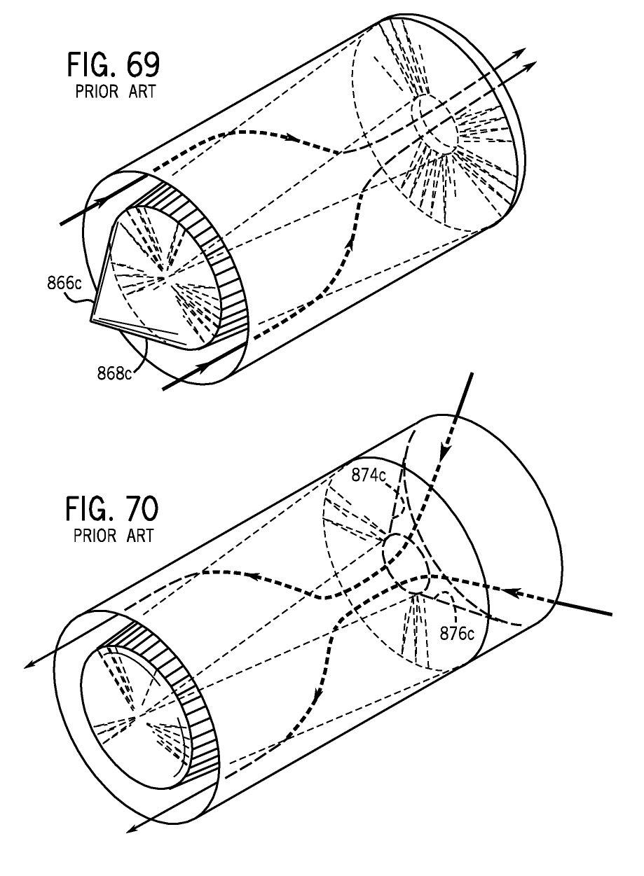

FIG. 69 is like FIG. 67 and shows another embodiment.

FIG. 70 is like FIG. 67 and shows reverse flow and a further embodiment, and shows the outlet end.

FIG. 71 is a perspective view of the filter of FIG. 70, showing the inlet end.

### Present Application

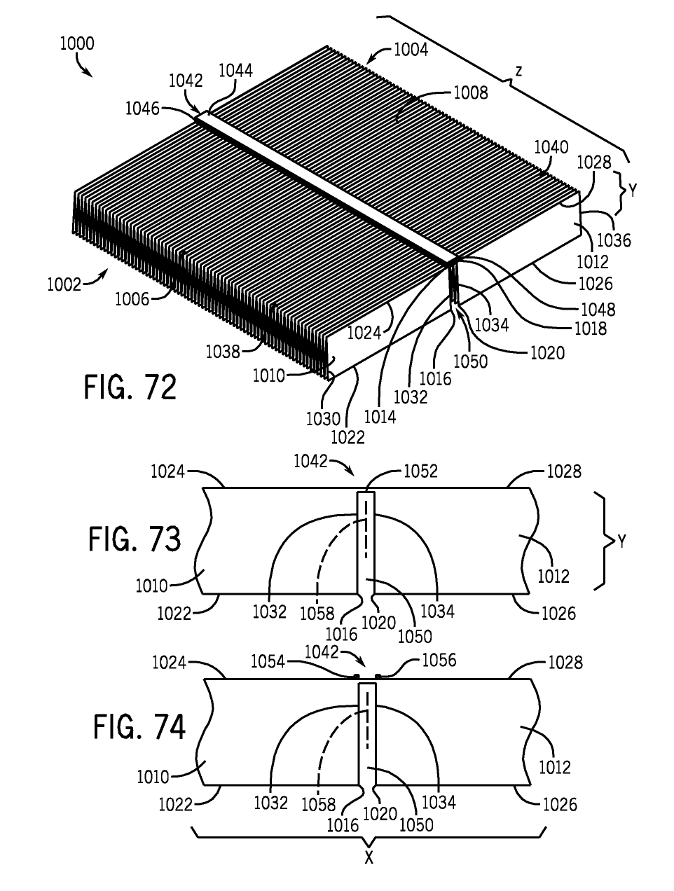

FIG. 72 is an isometric front view of one embodiment of a direct flow filter.

FIG. 73 provides a partial cross-sectional view through an axial and transverse plane of one embodiment of a direct flow filter.

FIG. 74 provides a partial cross-sectional view through an axial and transverse plane of another embodiment of a direct flow filter.

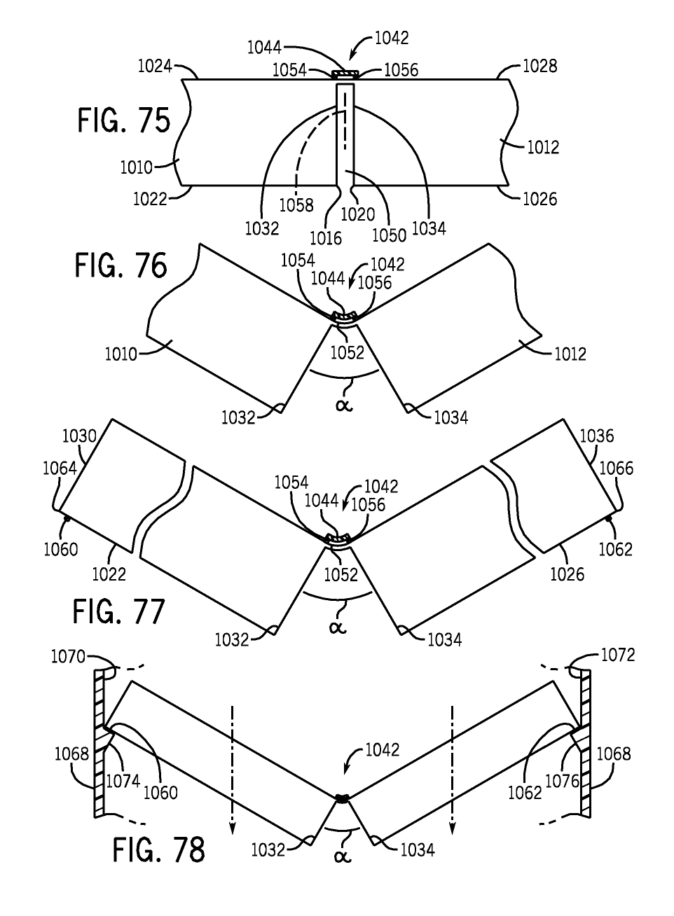

FIG. 75 provides a partial cross-sectional view through an axial and transverse plane of a direct flow filter according to FIG. 72.

FIG. 76 provides a partial cross-sectional view through an axial and transverse plane of another embodiment of a direct flow filter of FIG. 75 folded into a V-shaped geometry.

FIG. 77 provides a cross-sectional view through an axial and transverse plane of another embodiment of a direct flow filter having a V-shaped geometry.

FIG. 78 provides a cross-sectional view through an axial and transverse plane of another embodiment of a direct flow filter having a V-shaped geometry according to FIG. 77 and attached to a frame.

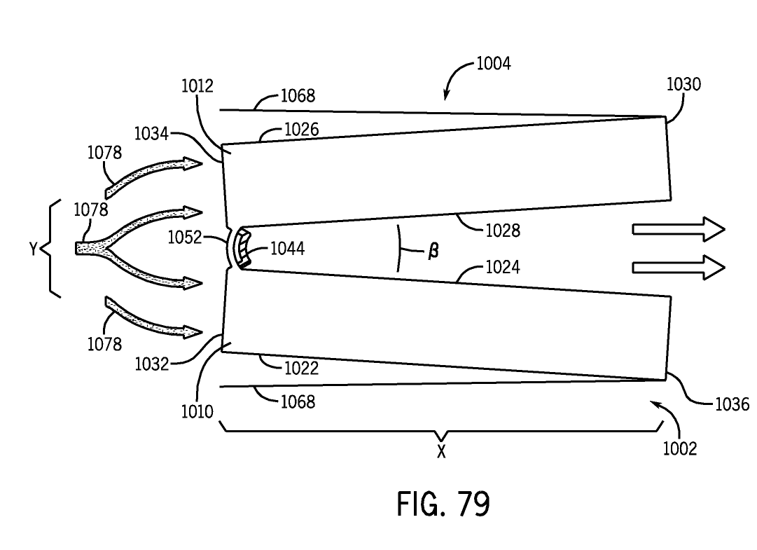

FIG. 79 provides a cross-sectional view through an axial and transverse plane of another embodiment of a direct flow filter having a V-shaped geometry.

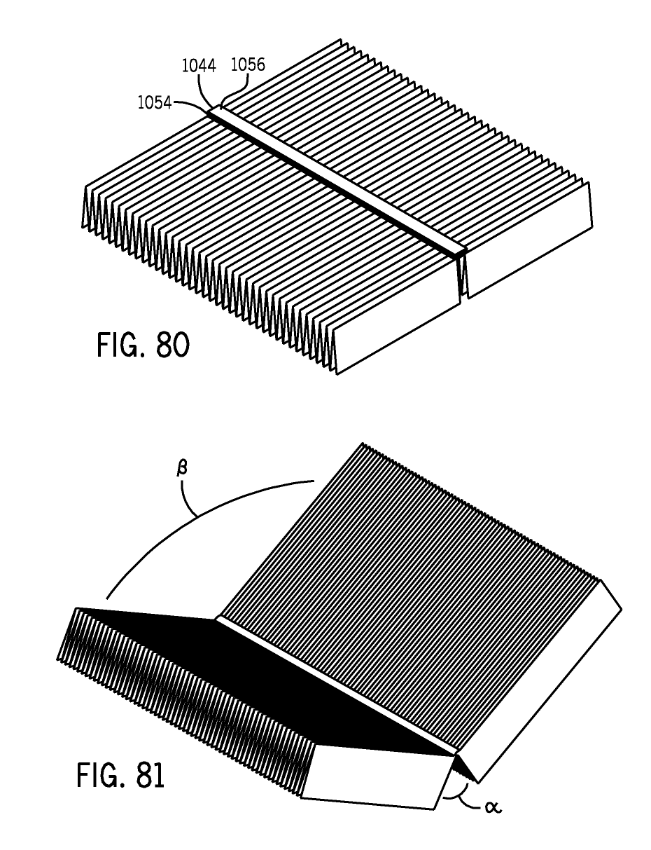

FIG. 80 is an isometric front view of one embodiment of a direct flow filter.

FIG. 81 is an isometric front view of the direct flow filter of FIG. 80 in which the first filter portion and second filter portion have been folded together at an angle.

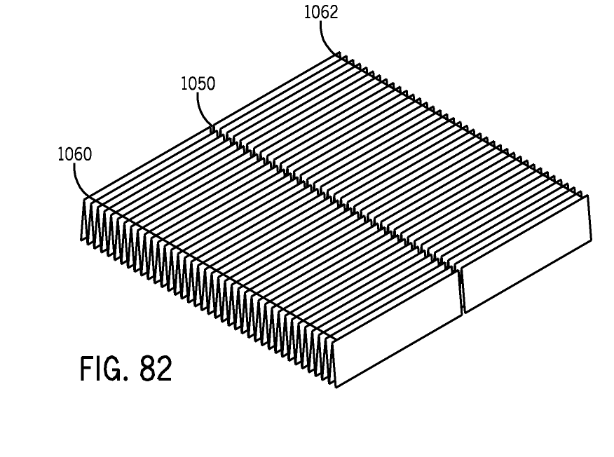

FIG. 82 is an isometric back view of the direct flow filter of FIG. 80.

### DETAILED DESCRIPTION

### Prior Art

Direct flow filters are disclosed in the prior art including U.S. Pat. Nos. 7,314,558 and 7,323,106; U.S. publication nos. 2006/0065592, 2008/0011672, and 2008/0011673; and international publication nos. WO2008/0067029 and WO2008/067030, the contents of which are incorporated herein by reference in their entireties. The following description of FIGS. 1-71 is taken from the above noted U.S. publication no. 2008/0011673.

FIG. 1 shows a filter 10 including a housing 12 extending axially along axis 14 and having an inlet 16 at one axial end 18 of the housing and having an outlet 20 at a distally opposite axial end 22 of the housing. The housing is preferably plastic and provided by identical upper and lower half sections 24 and 26 mating along diagonal flanges 28, 30, lateral flanges 32, 34, diagonal flanges 36, 38, and lateral flanges 40, 42.

A pleated filter block is provided by pleated filter element 44 in the housing. The pleated filter element is pleated along a plurality of upper bend lines 46 and lower bend lines 48, which bend lines extend axially. The filter element has a plurality of wall segments 50 extending in serpentine manner between the upper and lower bend lines. The wall segments extend axially between upstream ends 52 at inlet 16, and downstream ends 54 at outlet 20. The wall segments define axial flow channels 55 therebetween, FIG. 2. The upstream ends of the wall segments are alternately sealed to each other, as shown at 56 in FIG. 2, to define a first set of flow channels 58 having open upstream ends 60, and a second set of flow channels 62 interdigitated with the first set of flow channels 58 and having closed upstream ends 64. The downstream ends 54 of wall segments 50 are alternately sealed to each other, as shown at 66 in FIG. 2, such that the first set of flow channels 58 have closed downstream ends 68, and the second set of flow channels 62 have open downstream ends 70. Fluid to be filtered, which may include gas or liquid, flows substantially directly axially through filter element 44, namely from inlet 16 through open upstream ends 60 of the first set of flow channels 58 as shown at arrows 72, then through wall segments 50 as shown at arrows 74, then through open downstream ends 70 of the second set of flow channels 62 as shown at arrows 76, then to outlet 20. It is preferred that at least a portion of each of inlet 16 and outlet 20 are axially aligned.

Filter element 44 has laterally distally opposite right and left axially extending sides 78 and 80, FIG. 1, defining first and second axially extending planes. The second axial plane at side 80 is parallel to and spaced from the first axial plane at side 78. Upper bend lines 46 provide a first or upper set of coplanar bend lines defining a third axially extending plane. Lower bend lines 48 define a lower or second set of coplanar bend lines defining a fourth axially extending plane. The fourth axial plane at lower bend lines 48 is parallel to and spaced from the third axial plane at upper bend lines 46. The third and fourth axial planes are perpendicular to the noted first and second axial planes. Upstream ends 52 of wall segments 50 define a first laterally extending plane, and downstream ends 54 of the wall segments define a second laterally extending plane. The second lateral plane at downstream ends 54 is parallel to and spaced from the first lateral plane at upstream ends 52. The noted first and second lateral planes are perpendicular to the noted first and second axial planes and perpendicular to the noted third and fourth axial planes.

A gasket 82, FIGS. 1, 3, is provided for sealing filter 44 to housing 12, such that air entering inlet 16 cannot bypass the filter element to outlet 20, and instead must flow through the filter element as shown at arrows 72, 74, 76, FIG. 2. Gasket 82 has a first section 84 extending along the noted first axial plane along right side 78. Gasket 82 has a second section 86 extending along the noted second lateral plane at downstream ends 54 as shown at 88 in FIG. 3, and also extending along the noted third axial plane at upper bend lines 46, as shown at 90 in FIG. 3. In alternate embodiments, second section 86 of gasket 82 extends along only one or the other of the noted second lateral plane at 88 or third axial plane at 90, but not both. Gasket 82 has a third section 92 extending along the noted second axial plane along left side 80. Gasket 82 has a fourth section 94 extending along the noted first lateral plane at upstream ends 52 of wall segments 50, and also extending along the noted fourth axial plane at lower bend lines 48, comparably to FIG. 3. In alternate embodiments, fourth section 94 of gasket 82 extends along only one or the other of the noted first lateral plane and fourth axial plane, but not both. Gasket 82 is preferably adhesively secured to filter element 44 along each of the noted gasket sections 84, 86, 92, 94, such that filter element 44 and gasket 82 are replaced as a modular unit. It is further preferred that the upper and lower surfaces of the gasket, such as 96 and 98, FIG. 3, be pinched and compressed between respective housing flanges such as 32 and 34, with such outer peripheral sandwich arrangement being held in assembled condition by any suitable means, such as clip 100, clamps, bolts, or the like. In alternate embodiments, other surfaces of the gasket may be used as the sealing surface against the housing. First and third gasket sections 84 and 92 extend obliquely relative to axis 14. Second and fourth gasket sections 86 and 94 extend perpendicularly to the noted first and second axial planes. Second and fourth gasket sections 86 and 94 are axially spaced, and first and third gasket sections 84 and 92 extend diagonally between second and fourth gasket sections 86 and 94.

FIG. 4 shows a further embodiment having a plurality of filter elements 44a, 44b, 44c stacked on each other. The filter elements have respective wall segments 50a, 50b, 50c with upstream ends 52a, 52b, 52c and downstream ends 54a, 54b, 54c. Upstream ends 52a, 52b, 52c of the wall segments are coplanar along a first laterally extending plane. Downstream ends 54a, 54b, 54c are coplanar along a second laterally extending plane. The second lateral plane is parallel to and spaced from the first lateral plane. The filter elements have respective laterally distally opposite right and left sides 78a and 80a, 78b and 80b, 78c and 80c. Right sides 78a, 78b, 78c are coplanar along a first axially extending plane. Left sides 80a, 80b, 80c are coplanar along a second axially extending plane. The second axial plane is parallel to and spaced from the first axial plane. The filter elements 44a, 44b, 44c have respective upper sets of coplanar bend lines 46a, 46b, 46c, and lower sets of coplanar bend lines 48a, 48b, 48c. The upper set of coplanar bend lines 46a of top filter 44a defines a third axially extending plane. The lower set of coplanar bend lines 48c of the bottom filter element 44c defines a fourth axially extending plane. The fourth axial plane is parallel to and spaced from the third axial plane. The third and fourth axial planes are perpendicular to the first and second axial planes. The noted first and second lateral planes are perpendicular to the noted first and second axial planes and perpendicular to the noted third and fourth axial planes. Gasket 82a has a first section 84a extending along the noted first axial plane along right sides 78a, 78b, 78c. Gasket 82a has a second section 86a extending along the noted second lateral plane along downstream ends 54a, and also along the noted third axial plane along upper bend lines 46a. In alternate embodiments, gasket section 86a extends along only one or the other of the noted second lateral plane along downstream ends 54a or along the noted third axial plane along upper bend lines 46a, but not both. Gasket 82a has a third section 92a extending along the noted second axial plane along left sides 80a, 80b, 80c. Gasket 82a has a fourth section 94a extending along the noted first lateral plane along upstream ends 52a, 52b, 52c, and also extending along the noted fourth axial plane along lower bend lines 48c. In alternate embodiments, gasket section 94a extends along only one of the noted first lateral plane along upstream ends 52a, 52b, 52c or the noted fourth axial plane along lower bend lines 48c, but not both. The construction in FIG. 4 provides a pleated filter block having one or more rows of wall segments 50a, 50b, 50c folded in serpentine manner between respective bend lines, and providing filtered fluid flow substantially directly axially through the filter block along axis 14. First and third gasket sections 84a and 92a extend obliquely relative to axis 14. Second and fourth gasket sections 86a and 94a extend perpendicularly to the noted first and second axial planes. Second and fourth gasket sections 86a and 94a are axially spaced, and first and third gasket sections 84a and 92a extend diagonally between second and fourth gasket sections 86a and 94a.

FIG. 5 shows a further embodiment, and uses like reference numerals from above where appropriate to facilitate understanding. Filter 10a includes a housing 12a extending axially along axis 14 and having an inlet 16a at one axial end 18a of the housing and having an outlet 20a at a distally opposite axial end 22a of the housing. The housing is preferably plastic and provided by a box-like member 102 having an outer peripheral flange 104 mating with flange 106 of housing end 22a and pinching gasket 82b therebetween. Gasket 82b seals pleated filter block 44 or 44a in the housing. Unlike first and third sections 84 and 92 of gasket 82 in FIG. 1, first and third sections 84b and 92b of gasket 82b in FIG. 5 extend perpendicularly relative to the noted third and fourth axial planes. Like second and fourth sections 86 and 94 of gasket 82 in FIG. 1, second and fourth sections 86b and 94b of gasket 82b in FIG. 5 extend perpendicularly to the noted first and second axial planes. Gasket 82b has first section 84b extending along the noted first axial plane along right side 78 and also preferably extending along one of the noted lateral planes preferably the noted second lateral plane along downstream ends 54. Gasket 82b has second section 86b extending along the noted third axial plane along upper bend lines 46 and also along the noted one lateral plane preferably the lateral plane along downstream ends 54. Gasket 82b has third section 92b extending along the noted second axial plane along left side 80 and preferably along the noted one lateral plane preferably the lateral plane formed at downstream ends 54. Gasket 82b has fourth section 94b extending along the noted fourth axial plane along the noted lower bend lines 48 and also preferably along the noted one lateral plane preferably the lateral plane along downstream ends 54.

FIG. 6 shows a further embodiment and uses like reference numerals from above where appropriate to facilitate understanding. Filter elements 44a, 44b, 44c, 44d are stacked on each other. Gasket 82c corresponds to gasket 82b of FIG. 5 and includes corresponding gasket sections 84c, 86c, 92c, 94c.

FIG. 7 is similar to FIG. 6 and uses like reference numerals from above where appropriate to facilitate understanding. Layers of sealing material 110, 112, etc. are between respective adjacent stacked filter elements, FIG. 8. In one embodiment, each layer 110, 112, etc. is impervious to the noted fluid to be filtered. In another embodiment, each layer 110, 112, etc. is pervious to such fluid and filters fluid flow therethrough. In the embodiment of FIGS. 7 and 8, each layer 110, 112, etc. spans the entire area between upstream ends 52 and downstream ends 54 and between right and left sides 78 and 80.

FIGS. 9-15 show another embodiment wherein the noted sealing layers of FIGS. 7 and 8 need not span the entire noted area between upstream and downstream ends 52 and 54 and right and left sides 78 and 80. In FIGS. 9-15, the noted sealing layers are provided by alternating strip layers such as 120, 122, 124, 126, 128, FIGS. 9, 10, including a first set of one or more upstream laterally extending strip layers 122, 126, etc., and a second set of one or more downstream laterally extending strip layers 120, 124, 128, etc., interdigitated with the first set of strip layers. Each strip layer 122, 126, etc. of the first set extends laterally between the right and left sides 78 and 80 at upstream end 52 and extends along the lower bend lines of the filter element thereabove and the upper bend lines of the filter element therebelow. Each strip layer 120, 124, 128, etc. of the second set extends laterally between right and left sides 78 and 80 at downstream end 54 and extends along the lower bend lines of the filter element thereabove and the upper bend lines of the filter element therebelow. A given filter element, e.g. 44b, has a strip layer 122 of the first set extending laterally along its upper bend lines at upstream end 52, and a strip layer 124 of the second set extending laterally along its lower bend lines at downstream end 54. Filter element 44b has no strip layer along its upper bend lines at downstream end 54, and has no strip layer along its lower bend lines at upstream end 52.

A first filter element such as 44a has a first strip layer 122 of the first set extending along its lower bend lines at upstream end 52, a second filter element such as 44b has a first strip layer 124 of the second set extending laterally along its lower bend lines at downstream end 54, a third filter element such as 44c has a second strip layer 126 of the first set extending along its lower bend lines at upstream end 52. The noted first and second filter elements 44a and 44b have the first strip layer 122 of the first set extending laterally therebetween at upstream end 52. The noted first and second filter elements 44a and 44b have no strip layer extending laterally therebetween at downstream end 54. The noted second and third filter elements 44b and 44c have first strip layer 124 of the second set extending laterally therebetween at downstream end 54. The noted second and third filter elements 44b and 44c have no strip layer extending laterally therebetween at upstream end 52.

As shown in FIGS. 13 and 14, the closed upstream ends of the noted second set of flow channels are closed by sealing material such as 130 at filter element 44a, 132 at filter element 44b, 134 at filter element 44c, 136 at filter element 44d. The closed downstream ends of the first set of flow channels are closed by sealing material such as 138, FIG. 15, at filter element 44a, 140 at filter element 44b, 142 at filter element 44c, 144 at filter element 44d. Lateral sealing strip 122, FIGS. 13, 14, is sealed to the sealing material 130 in the closed upstream ends of the flow channels of filter element 44a thereabove and is sealed to sealing material 132 in the closed upstream ends of the flow channels of filter element 44b therebelow. Lateral strip 122 may be adhesively bonded to sealing material 130, 132, or may be integrally formed therewith as in a hot melt application, or the like. Lateral strip 126 is sealed to sealing material 134 in the closed upstream ends of the flow channels of filter element 44c thereabove and is sealed to the closed upstream ends of the flow channels of filter element 44d therebelow. Lateral sealing strip 124, FIG. 15, is sealed to sealing material 140 in the closed downstream ends of the flow channels of filter element 44b thereabove and is sealed to sealing material 142 in the closed downstream ends of the flow channels of filter element 44c therebelow. The described sealing protects the downstream, clean areas of the filter from the upstream, dirty areas of the filter.

In FIGS. 9-15, the noted sealing layers are also provided by a right set of axially extending side edge layers 146, 148, 150, etc., FIGS. 9, 11, 12, 13, 14, and a left set of axially extending side edge layers 152, 154, 156, etc. Each side edge layer of the right set extends axially from upstream end 52 to downstream end 54 and engages the right side of the filter element thereabove and the right side of the filter element therebelow such that the right side of the filter element is sealed to the right side of the filter element thereabove and to the right side of the filter element therebelow. Each side edge layer of the left set extends axially from upstream end 52 to downstream end 54 and engages the left side of the filter element thereabove and the left side of the filter element therebelow such that the left side of the filter element is sealed to the left side of the filter element thereabove and to the left side of the filter element therebelow. Side edge layers 148 and 154 are optional because of the sealing provided by downstream lateral sealing strip layer 124. FIGS. 13 and 14 show deletion of side edge layers 148 and 154. The noted lateral strip layers and side edge layers protect downstream and clean areas of the filter are from the upstream and dirty areas of the filter. The noted strip layers and edge layers are preferably provided by adhesive such as hot melt, though other types of sealing strips may be used.

FIGS. 16-23 use like reference numerals from above where appropriate to facilitate understanding.

FIGS. 16 and 17 show a filter 200 for filtering fluid flowing along an axial flow direction 14, FIGS. 1, 2, as shown at inlet flow arrows 202, FIG. 16 and outlet flow arrows 204, FIG. 17. The filter has a pair of panels or rows of pleated filter elements 206 and 208. Each filter element has a plurality of pleats defined by wall segments 50, FIGS. 1, 2, extending along a transverse direction 210 between first and second sets of pleat tips at first and second sets of axially extending bend lines 46 and 48. Transverse direction 210 is perpendicular to axial direction 14. Each of the panels 206 and 208 extends along a lateral direction 212 perpendicular to axial direction 14 and perpendicular to transverse direction 210. Wall segments 50 extend axially between upstream and downstream ends 52 and 54. The wall segments define axial flow channels 55 therebetween. The upstream ends of the wall segments are alternately sealed to each other, as shown at 56 in FIG. 2, to define a first set of flow channels 58 having open upstream ends 60, and a second set of flow channels 62 interdigitated with the first set of flow channels 58 and having closed upstream ends 64. The downstream ends 54 of wall segments 50 are alternately sealed to each other, as shown at 66 in FIG. 2, such that the first set of flow channels 58 have closed downstream ends 68, and the second set of flow channels 62 have open downstream ends 70. Fluid to be filtered, such as air, flows substantially directly axially through the filter element 44 of each of the panels 206, 208, through open upstream ends 60 of the first set of flow channels 58 as shown at arrows 72, FIG. 2, then through wall segments 50 as shown at arrows 74, then through open downstream ends 70 of the second set of flow channels 62 as shown at arrows 76.

Panels 206 and 208 have a transverse gap 214, FIG. 16, therebetween at upstream end 52, and are sealed to each other at downstream end 54 by sealing strip 216 which may be part of cover flange 218 at the downstream end of filter housing 220. Gap 214 provides additional fluid flow axially therethrough as shown at arrow 222, FIG. 18, i.e. fluid flows axially through the filter as described above and shown at arrows 72, 74, 76, FIG. 2, and additionally flows through the filter as shown at arrows 222, 224, 226, FIG. 18. Housing 220 includes laterally extending sidewalls 228 and 230 generally parallel to panels 206 and 208 and spaced transversally on distally opposite sides thereof. Housing 220 also includes sidewalls 232 and 234 extending transversely between lateral sidewalls 228 and 230. Sidewalls 228 and 230 are preferably slightly tapered outwardly away from each other from upstream end 52 to downstream end 54 and are sealed at their upstream ends to respective panels 206, 208, and have transverse gaps 236, 238 formed between sidewalls 228, 230 and respective panels 206, 208 at the downstream end providing the noted additional fluid flow 226 axially therethrough. In one embodiment, the filter panels are sealed to the housing by adhesive, and in another embodiment, the filter panels are sealed to the housing by a gasket as above described. In a further embodiment, the flow direction may be reversed such that incoming fluid flow enters the filter at end 54 through flow channels 70 and gaps 236, 238, and exits the filter at end 52 through flow channels 58 and gap 214.

FIGS. 21-23 show a further embodiment and a use like reference numerals from above where appropriate to facilitate understanding. First, second, third and fourth panels or rows 206, 208, 240, 242 of pleated filter elements 44 are provided. Two transverse gaps 214, 244 are provided between panels at upstream end 52, and one transverse gap 246 is provided between panels at downstream end 54. An additional downstream transverse gap 236, FIG. 23, is provided between housing sidewall 228 and panel 206, and another downstream transverse gap 248 is provided between panel 242 and housing sidewall 230. Transverse gap 214 is between panels 206 and 208. Transverse gap 244 is between panels 240 and 242. Transverse gap 246 is between panels 208 and 240. The transverse gap between panels 208 and 240 at upstream end 52 is closed and blocked at the upstream end by sealing strip 250 which may be part of the upstream end of the filter housing. The gap between panels 206 and 208 at downstream end 54 is blocked and closed by sealing strip 216, and the gap between panels 240 and 242 at downstream end 54 is blocked and closed by sealing strip 252, which sealing strips 216 and 252 may be part of cover flange 218 at the downstream end of the housing. Fluid flows axially through the filter as shown at arrows 72, 74, 76, FIG. 2. Fluid additionally flows through the filter, FIG. 23, as shown at arrows 222, 224, 226, as noted above, and at arrows 222a, 224a, 226a. Additional inlet flow is enabled by transverse gaps 214, 244. Additional outlet flow is enabled by transverse gaps 236, 246, 248. In a further embodiment, the flow direction may be reversed such that incoming fluid flow enters the filter at end 54 through flow channels 70 and gaps 236, 246, 248, and exits the filter at end 52 through flow channels 58 and gaps 214, 244.

FIGS. 24-26 show a filter 300 for filtering fluid flowing along an axial flow direction 302. The filter has at least one panel, and in the embodiment of FIGS. 24-26 two panels 304, 306, each having a pleated filter element 308, 310, respectively. Each filter element has a plurality of pleats such as 312 defined by wall segments 314 extending along a transverse direction 316 between first and second sets of pleat tips 318 and 320 at first and second sets of axially extending bend lines 322 and 324. Transverse direction 316 is perpendicular to axial direction 302. Each panel extends along a lateral direction 326 perpendicular to axial direction 302 and perpendicular to transverse direction 316. Wall segments 314 extend axially between upstream and downstream ends 328 and 330. The wall segments define axial flow channels 332 therebetween, for example like channels 55 noted above in conjunction with FIG. 2. As above, the upstream ends 328 of the wall segments 314 are alternately sealed to each other, as shown at 56 in FIG. 2, to define a first set of flow channels, e.g. 58, FIG. 2, having open upstream ends 60, and a second set of flow channels, e.g. 62, FIG. 2, interdigitated with the first set of flow channels and having closed upstream ends, e.g. 64, FIG. 2. The downstream ends 330 of the wall segments 314 are alternately sealed to each other, as shown at 66 in FIG. 2, such that the first set of flow channels, e.g. 58, have closed downstream ends, e.g. 68, and the second set of flow channels, e.g. 62, have open downstream ends, e.g. 70. As above, fluid to be filtered, such as air or other fluid, flows substantially directly axially through the filter, through the open upstream ends 60 of the first set of flow channels 58 as shown at arrows 72, then through wall segments 50, FIG. 2, 314, FIG. 24, as shown at arrows 74, FIG. 2, then through open downstream ends 70 of the second set of flow channels 62 as shown at arrows 76, FIG. 2. The dirty pre-filtered air is shown at stippled arrows 334. The clean filtered air is shown at arrows 336.

In comparing FIGS. 18 and 25, it is noted that the gaps between filter element panels 304 and 306 and between such panels and the sidewalls 338 and 340 of the housing are provided by angling the panels 304 and 306 in FIG. 25, whereas in FIG. 18 such gaps are provided by angling the housing sidewalls 228, 230. The downstream ends of housing sidewalls 338, 340 are sealed to respective filter element panels 304, 306. Gaps 342 and 344 taper to narrower transverse widths as they extend axially downstream. Gap 346 between filter element panels 304 and 306 tapers to a wider transverse width as it extends axially downstream. The upstream ends of the panels are sealed to each other at gap 346 by a sealing strip 348 extending along the noted lateral direction 326 and which may be like sealing strip 216, FIG. 18, noted above, and preferably having a leading aerodynamic shape such as a bullet nose. The top and bottom walls 350 and 352, FIG. 26 of the housing extend axially and transversely and are sealed to the upper and lower surfaces of the panels, as above, to prevent a bypass leak path. FIG. 27 shows another version with a single filter element panel 354. In each of FIGS. 24-27, and in the drawings noted below, the flow direction may be reversed, i.e. may flow from right to left, as also noted above in conjunction with FIG. 18.

FIGS. 28 and 29 show a further embodiment and use like reference numerals from above where appropriate to facilitate understanding. The filter includes third and fourth pleated filter element panels 356 and 358, comparably to the embodiment shown above in FIGS. 21-23. Transverse gap 360 between central panels 306 and 356 is open at its upstream end and tapers to transversely narrower width as it extends axially downstream. Gaps 346 and 362 between respective panels are closed by respective upstream sealing strips 348 and 364 and taper to wider transverse widths as they extend axially downstream. Gaps 342 and 344 are open at their upstream ends and taper to narrower transverse widths as they extend axially downstream.

FIGS. 30 and 31 show a further embodiment and use like reference numerals from above where appropriate to facilitate understanding. Pleated filter element 370 has wall segments 314 have progressively increasing separation therebetween along lateral direction 326 as the wall segments progress axially toward one of the upstream and downstream ends 328 and 330, to provide progressively increasing flow channel width along lateral direction 326. In FIG. 30, the lateral separation between the wall segments increases as the wall segments progress axially from upstream to downstream, i.e. left to right in FIG. 30. The pleated filter element panel has an upstream width 371 along lateral direction 326 equal to the cumulative flow channel widths along lateral direction 326 thereat. The panel has a downstream width 372 along lateral direction 326 at the downstream end equal to the cumulative flow channel widths along lateral direction 326. The downstream width 372 along lateral direction 326 is greater than the upstream width 371 along lateral direction 326. Housing 373 has a concording larger exit mouth 374 then entrance mouth 376.

FIGS. 32 and 33 show a further embodiment and use like reference numerals from above where appropriate to facilitate understanding. The filter includes first and second panels 380 and 382 of pleated filter elements. The first filter element panel 380 has a plurality of pleats, as above described, defined by wall segments 384 extending along a first transverse direction 386 between first and second sets of pleat tips 388 and 390 at first and second sets of axially extending bend lines 392 and 394. First transverse direction 386 is perpendicular to axial direction 302. First panel 380 extends along a first lateral direction 396 perpendicular to axial direction 302 and perpendicular to first transverse direction 386. Wall segments 384 of first filter element panel 380 extend axially between upstream and downstream ends, with such wall segments defining axial flow channels therebetween, and, as above, the upstream ends of the wall segments being alternately sealed to each other to define a first set of flow channels having open upstream ends, and a second set of flow channels interdigitated with the first set of flow channels and having closed upstream ends, the downstream ends of the wall segments being alternately sealed to each other such that the first set of flow channels have closed downstream ends, and the second set of flow channels have open downstream ends, such that fluid to be filtered flows substantially directly axially through the filter element, through the open upstream ends of the first set of flow channels then through the wall segments 384 then through the open downstream ends of the second set of flow channels. Second filter element panel 382 has a plurality of pleats defined by wall segments 398 extending along a second transverse direction 400 between third and fourth sets of pleat tips 402 and 404 at third and fourth sets of axially extending bend lines 406 and 408. Second transverse direction 400 is perpendicular to axial direction 302. Second panel 382 extends along a second lateral direction 410 perpendicular to axial direction 302 and perpendicular to second transverse direction 400. Wall segments 398 of second filter element panel 382 extend axially between upstream and downstream ends, as above, the wall segments 398 defining axial flow channels therebetween, the upstream ends of wall segments 398 being alternately sealed to each other to define a third set of flow channels having open upstream ends, and a fourth set of flow channels interdigitated with the third set of flow channels and having closed upstream ends, the downstream ends of wall segments 398 being alternately sealed to each other such that the third set of flow channels have closed downstream ends, and the fourth set of flow channels have open downstream ends, such that fluid to be filtered flows substantially directly axially through filter element 382, through the open upstream ends of the third set of flow channels then through wall segments 398 then through the open downstream ends of the fourth set of flow channels.

First and second transverse directions 386 and 400, FIGS. 32, 33, extend along respective first and second skewed projection lines intersecting each other at an apex 412, FIG. 33, and forming a V-shape therefrom. The V-shape is an inverted V-shape with an upper apex 412 and a pair of sides at 386 and 400 angled downwardly therefrom. The noted pleat tips 388 of the noted first set of pleat tips are at higher vertical levels, FIG. 33, then the respective pleat tips 390 of the noted second set of pleat tips, such that wall segments 384 of first filter element 380 slant downwardly from the first set of pleat tips 388 to the second set of pleat tips 390 at an angle greater than or equal to a friction angle of removed contaminant, such that contaminant slides along such wall segments and then drops as shown at arrow 414 to the bottom of the housing as shown at collection zone 416. The noted pleat tips 402 of the noted third set of pleat tips are at higher vertical levels then respective pleat tips 404 of the noted fourth set of pleat tips such that wall segments 398 of the second filter element 382 slant downwardly from the third set of pleat tips 402 to the fourth set of pleat tips 404 at an angle greater than or equal to a friction angle of removed contaminant, such that the contaminant slides downwardly along the wall segments 398 and then falls as shown at arrow 418 to collection zone 416. First and second lateral directions 396 and 410 are preferably parallel to each other.

FIGS. 34-39 show a further embodiment and use like reference numerals from above where appropriate to facilitate understanding. Pleated filter element panel 420 has a plurality of pleats, as above, defined by wall segments 314 extending along a transverse direction 316 between first and second sets of pleat tips 318 and 320 at first and second sets of axially extending bend lines 322 and 324. Transverse direction 316 is perpendicular to axial direction 302. The panel extends along lateral direction 326 perpendicular to axial direction 302 and perpendicular to transverse direction 316. Wall segments 314 extend axially between upstream and downstream ends 328 and 330 and define axial flow channels therebetween, as above, the upstream ends of the wall segments being alternately sealed to each other, FIG. 35, as above described, to define a first set of flow channels, such as 58, FIG. 2, having open upstream ends, and a second set of flow channels such as 62 interdigitated with the first set of flow channels and having closed upstream ends, the downstream ends of the wall segments being alternately sealed to each other such that the first set of flow channels have closed downstream ends, and the second set of flow channels have open downstream ends, such that fluid to be filtered flows substantially directly axially through the filter, through the open upstream ends of the first set of flow channels then through wall segments 314 then through the open downstream ends of the second set of flow channels.

In FIG. 36, the set of pleats tips 318 of FIG. 34 along axially extending bend lines 32 at upstream end 328 are flattened at 422 transversely along transverse direction 316 into respective flow channels such that the respective axially extending bend lines 322 bifurcate in a Y-shape and branch along diverging diagonally extending bend lines 424 and 426 at upstream end 328. The wall segments have respective triangular shaped portions 422 defined by and bounded by diverging bend lines 424 and 426 of the noted Y-shape. In one embodiment, the filter is mounted in a housing having a substantially flat sidewall sealing surface as shown in dashed line at 428 in FIG. 39, and the noted triangular portions 422 of the wall segments bounded by the noted Y-shapes are substantially flat and uniplanar and mate with the noted substantially flat sidewall sealing surface 428. In other embodiments, a pair of filter element panels 420 and 430, FIG. 37, each have the noted axially extending bend lines such as 322 and 432 which bifurcate in a Y-shape and branch along the noted diverging diagonally extending bend lines such as 424 and 434 at one or both of the upstream and downstream ends. The wall segments of each of the noted pair of filter element panels 420 and 430 at one or both of the upstream and downstream ends have respective triangular shaped portions such as 422 defined and bounded by respective diverging bend lines such as 424 and 426 of the respective Y-shape, with the triangular shaped portions of respective wall segments of the pair of filter elements bounded by respective Y-shapes being substantially flat and mating with each other, for example as shown at the flat mating engagement of bend lines 424 and 434. The opposite ends, e.g. the downstream ends in FIG. 37 may also have the noted bifurcation in a Y-shape providing the noted diverging bend lines such as 436 and 438, FIGS. 37, 38, for mating with other filter element panels or an enclosing housing.

The following description of FIGS. 40-47 is taken from U.S. Pat. No. 6,511,599, FIGS. 28-35, respectively.

FIG. 40 shows a filter 600 for filtering fluid flowing along an axial flow direction 602. Concentric cylindrical pleated filter elements 604, 606 have a common axis 608 extending along axial flow direction 602. Each filter element has a plurality of pleats, such as 28, FIGS. 5-9 of U.S. Pat. No. 6,511,599, defined by wall segments 610 extending radially in serpentine manner between inner and outer sets of pleat tips, such as 36 and 38, respectively, at inner and outer sets of axially extending fold or bend lines 612 and 614, respectively. The wall segments extend axially between upstream and downstream ends 326 and 328. The wall segments define axial flow channels 106, 108 therebetween. Upstream ends of the wall segments are alternately sealed to each other, as above at 110, to define a first set of flow channels 106 having open upstream ends 616, FIG. 42, and a second set of flow channels 108 interdigitated with the first set of flow channels 106 and having a closed upstream ends 618. The downstream ends of the wall segments are alternately sealed to each other, as above, such that the first set of flow channels 106 have closed downstream ends 620, and the second set of flow channels 108 have open downstream ends 622. As above, fluid to be filtered flows substantially directly axially as shown at 602 through the filter, through open upstream ends 616 of the first set of flow channels 106 as shown at flow arrows 624, then through the wall segments 610 as shown at flow arrows 626, then through open downstream ends 622 of the second set of flow channels 108 as shown at flow arrow 628. The flow described thus far is like that shown in FIGS. 15 and 27 of U.S. Pat. No. 6,511,599.

Cylindrical filter elements 604 and 606 have a radial gap 630 therebetween, FIGS. 28, 31, at upstream end 326, and are sealed to each other at annular seal 632 at downstream end 328. Gap 630 provides additional axial flow therethrough as shown at flow arrow 634, FIGS. 40, 43. Filter element 606 concentrically surrounds filter element 604. Filter element 604 has a hollow interior 636, FIGS. 41, 43, having an open end 638 at downstream end 328, and having a closed end 640 at upstream end 326 closed by sealing end cap 642 comparable to end cap 342, FIG. 15 of U.S. Pat. No. 6,511,599, and end cap 514, FIG. 27 of U.S. Pat. No. 6,511,599. Open end 638 of hollow interior 636 provides additional fluid flow axially therethrough, as shown at flow arrows 644, 646, FIG. 44.

Filter 600 is mounted in a housing 648, FIG. 44, having an axially extending sidewall 650 spaced radially outwardly of filter element 606 by a radial gap 652 at downstream end 328. Sidewall 650 and filter element 606 are sealed to each other at upstream end 326 by annular seal 654. Gap 652 provides additional fluid flow axially therethrough as shown at flow arrows 656, 658. Seals 642 and 654 are at upstream end 326, and seal 632 is at downstream end 328. Seal 642 is a central seal closing hollow interior 636. Seal 632 is an annular seal concentrically surrounding filter element 604 and closing gap 630 at downstream end 328 by sealing filter elements 604 and 606 to each other. Seal 654 is an annular seal concentrically surrounding filter element 606 and closing gap 652 at upstream end 326 by sealing filter element 606 and sidewall 650 to each other. In a further embodiment, the flow direction may be reversed, as shown in FIG. 45.

FIGS. 46 and 47 show a further embodiment and use like reference numerals from above where appropriate to facilitate understanding. Filter 660 has a plurality of concentric cylindrical filter elements 604, 606, 662, 664, 666 having respective radial gaps 630, 668, 670, 672 therebetween. Radial gaps 630 and 670 are at upstream end 326. Radial gaps 668 and 672 are at downstream end 328. Filter element 662 concentrically surrounds filter element 606. Filter elements 606 and 662 have annular radial gap 668 therebetween at downstream end 328. Radial gap 668 provides additional flow axially therethrough. Filter element 664 concentrically surrounds filter element 662. Filter elements 662 and 664 have annular radial gap 670 therebetween at upstream end 326. Radial gap 670 provides additional flow axially therethrough. Filter element 666 concentrically surrounds filter element 664. Filter elements 664 and 666 have annular radial gap 672 therebetween at downstream end 328. Radial gap 672 provides additional flow axially therethrough. Filter elements 606 and 662 are sealed to each other at annular sealing ring 674 at upstream end 326. Filter elements 662 and 664 are sealed to each other at annular sealing ring 676 at downstream end 328. Filter elements 664 and 666 are sealed to each other at annular sealing ring 678 at upstream end 326.

The following description of FIGS. 48-56 is taken from the noted parent '619 application.

FIGS. 48-50 show a filter 700 including a plurality of pleated filter elements 702, 704, 706 pleated along axially extending bend lines such as 708 to form axially extending channels such as 710 extending axially along an axial direction 712 from an upstream end 714 to a downstream end 716. Each channel has a pleat height or a channel height such as 718 extending transversely along a transverse direction 720 perpendicular to axial direction 712. Each channel has a channel width such as 722 extending laterally along a lateral direction 724 perpendicular to transverse direction 720 and perpendicular to axial direction 712. In FIG. 50, lateral direction 724 is into the page. The channels are alternately sealed at their upstream and downstream ends, as above, to provide a first set of channels open at their upstream ends and closed at their downstream ends, and a second set of flow channels closed at their upstream ends and open at their downstream ends.

First and second filter elements 702 and 704 have a first transverse gap 726 therebetween at one of the upstream and downstream ends, for example at upstream end 714 in FIG. 50, and are sealed to each other by a seal such as 728 at the other of the upstream and downstream ends, for example downstream end 716 in FIG. 50. First gap 726 provides additional fluid flow axially therethrough, as above. Second and third filter elements 704 and 706 have a second transverse gap 730 therebetween at the other of the upstream and downstream ends, for example downstream end 716 in FIG. 50, and are sealed to each other by a seal 732 at the noted one of the upstream and downstream ends, for example upstream 714 in FIG. 50. Second gap 730 provides additional fluid flow axially therethrough, as above,

The pleat channel height of at least one of the filter elements is different than the pleat channel height of at least one of the other filter elements, and preferably is different than the pleat channel height of each of the other filter elements, and further preferably the pleat channel height of each of the filter elements is different than the pleat channel height of each of the other filter elements. In FIGS. 48-50, the filter elements are concentric annuli. Third filter element 706 surrounds second filter element 704 and has a channel height 718 greater than the channel height 734 of the second filter element. Second filter element 704 surrounds first filter element 702 and has a channel height 734 greater than the channel height 736 of the first filter element. The filter elements are housed in a housing 738. An annular spacer ring 740 extends transversely between the housing and outer filter element 706. The spacer ring is at one of the upstream and downstream ends, for example at upstream end 714 in FIGS. 49, 50, and the transverse gap 742 between housing 738 and outer filter element 706 is sealed by a seal 744 at the other of the upstream and downstream ends, for example at downstream end 716 in FIG. 50. Spacer ring 740 passes fluid flow axially therethrough. Center gap 746 in the interior of the central filter element 702 is sealed by seal 748. Fluid may flow axially from end 714 to end 716, which is left to right in FIGS. 48 and 49, and upwardly in FIG. 50. Alternatively, in a reverse flow filter, the fluid may flow in the opposite direction, namely from end 716 to end 714, which is right to left in FIGS. 48 and 49, and downwardly in FIG. 51.

The noted concentric annuli have a shape selected from the group consisting of a circular shape, for example as shown in FIGS. 48-50, an oval shape, a racetrack shape, for example as shown in FIGS. 52, 53, an obround shape, and other closed-loop shapes. As used herein, annular includes all of these shapes. FIGS. 52, 53 show annular racetrack shaped filter elements 750, 752, 754 having the noted differing pleat channel heights 736, 734, 718, respectively, and housed in a housing 756 having a spacer ring 758. FIG. 54 shows another embodiment having a first filter element 760, which may be rectangular, and a second surrounding filter element 762, which filter elements have different pleat channel heights.

As above, the filter elements may be angled with respect to each other, for example as shown in FIG. 55 at angled filter elements 764 and 766 in filter housing 768 angled with respect to each other as they extend axially from upstream end 770 to downstream end 772 to provide transverse gap 774 therebetween of changing transverse width. Gap 774 tapers from a first transverse width such as 776 at one of the upstream and downstream ends, for example upstream end 770, to a second transverse width such as 778 at the other of the upstream and downstream ends, for example downstream end 772. One of the first and second transverse widths is greater than the other, for example second transverse width 778 is greater than first transverse width 776. One of such transverse widths is sealed by a sealing member such as 780 extending transversely between the first and second filter elements 764 and 766. Fluid may flow axially left to right from end 770 to end 772 as shown in FIG. 55, or alternatively fluid may flow in the opposite axial direction as shown in FIG. 56 from right to left from end 772 to end 770.

Also as above, at least some of the noted axially extending bend lines 708 along a portion thereof at least one of the upstream and downstream ends may be flattened transversely, e.g. at 422, FIG. 36, along the noted transverse direction into respective channels such that the respective axially extending bend lines bifurcate in a Y-shape and branch along diverging diagonally extending bend lines, e.g. 424 and 426, at at least one of the upstream and downstream ends. The filter elements may thus have at one or both of the upstream and downstream ends respective triangular shaped portions defined by and bounded by diverging bend lines of Y-shapes. The filter is mounted in a housing having a sidewall sealing surface, which housing sidewall may be curved as in FIG. 49, or have curved portions and flat rectilinear portions as in FIG. 53. The noted triangular portions bounded by Y-shapes mate with the noted sidewall sealing surface. Each of multiple filter elements may have the noted axially extending bend lines which bifurcate in a Y-shape and branch along diverging diagonally extending bend lines at one or both of the upstream and downstream ends, and each of such multiple filter elements at a respective one of the upstream and downstream ends may have respective triangular shaped portions defined by and bounded by respective diverging bend lines of the Y-shapes, which triangular shaped portions of the multiple filter elements bounded by respective Y-shapes mate with each other.

The disclosed constructions enable optimum pleat spacing, achieving a maximum media utilization coefficient. Furthermore, the contaminant will not clog the filter inlet because there are allowable contaminant passages such as 726, 742 between the coupled filtration units. The contaminant accumulation on the inlet face is reduced. Thus, the contaminant cake is distributed more uniformly along the entire filter element axial length. Because of the uniform contaminant mass distribution, filter pressure drop decreases, and filter life increases. The high filter media utilization factor, reduced pressure drop, and long life, are achieved in a reduced volume filter housing. The noted spacers such as 740, 758 may be a separate piece, or may be attached directly to the filter, or may be integrated into an inlet duct. Filter position may also be secured using hotmelt beads or other plastic or metal members. The housing such as 738, 756 may be metal or plastic. If desired, handles such as 790, 792 may be formed with or attached to the filter element, to assist in filter servicing, e.g. by grabbing the handle and pulling the multi-element filter unit axially leftwardly in FIGS. 49, 53 out of the respective housing 738, 756. The multi-element filter units may have an odd number of filter elements, e.g. three elements as in FIGS. 48-53, or may have an even number of filter elements, e.g. two elements as in FIGS. 54-56, or four elements, etc. The transverse space or gap between the layers or elements, e.g. gaps 746, 726, 730, 742, 774, may be modified so that there are larger or smaller gaps depending upon the particular customer's restriction and capacity requirements. For example, a design can utilize a larger gap for customers who don't require large dust-holding capacity, but do require low restriction in a particular package size. These large gaps between pleat blocks or filter elements would occupy space that would otherwise be used for media area, but they would result in lower system restriction and would meet a low dust-holding capacity requirement. The seals between elements, e.g. 732, 780 may have a bullet-shape to decrease flow restriction. The combined filter element unit may be sealed to the housing by an outer seal such as 744 by an axial and/or radial sealing force. Air cleaner applications are a desirable implementation of the disclosed constructions. Coalescer applications are also a desirable implementation, and it is an advantage that the lowest velocity is farthest from the entrance to the filter and at the point where the release and drainage of captured droplets occurs. This low velocity minimizes break-up of drops upon their release. In some applications, it may be desirable to reverse the flow and provide increasing velocity with distance from the filter entrance, which may be an advantage when diffusion and/or interception are the dominant capture mechanisms, and there are few large dense impacted particles to collect at the filter inlet. Various types of filter media may be used for the pleated filter elements, as is known.

FIGS. 57-59 show a direct flow filter 800 for filtering fluid flowing along an axial flow direction 802 from an upstream axial end 804 to a downstream axial end 806. Pleated filter portions 808, 810 are like those shown above at 304, 306, FIG. 24, each having a plurality of pleats such as 812 defined by wall segments 814 extending along a transverse direction 816 between first and second sets of pleat tips 818 and 820 at first and second sets of axially extending bend lines 822 and 824, all as above. Transverse direction 816 is perpendicular to axial direction 802. Each filter portion 808, 810 extends along a lateral direction 826 perpendicular to axial direction 802 and perpendicular to transverse direction 816. Wall segments 814 extend axially between upstream and downstream axial ends 828 and 830. The wall segments define axial flow channels 832 therebetween, for example like channels 332 noted above in conjunction with FIG. 24, and channels 55 noted above in conjunction with FIG. 2. The channels have a channel width extending along lateral direction 826 between respective wall segments. Filter portions 808 and 810 have a transverse gap therebetween at one of the upstream and downstream axial ends, for example transverse gap 834 at downstream end 806. Portions 808 and 810 are sealed to each other at the other of the upstream and downstream axial ends, for example by sealing strip 836. The wall segments define an upstream face 838 at the upstream axial end, and a downstream face 840, 842 at the downstream axial end. At least one of the upstream and downstream faces has a face seal transversely spanning from one of the first and second sets of pleat tips 818 and 820 at least partially towards the other of the first and second sets of pleat tips and laterally spanning adjacent channels 832. In the embodiment of FIGS. 57-59, upstream face seal 836 transversely spans all the way between respective pleat tips and laterally spans all adjacent channels. Face seals 840, 842 likewise transversely span all the way between respective sets of pleats tips, and laterally span all adjacent channels. Incoming dirty fluid flow can thus only flow into outer gaps 844 and 846, as shown at arrows 848 and 850, whereafter the fluid passes through the filtering wall segments of filter portions 808 and 810 and then clean filtered fluid can only exit through central gap 834 as shown at arrows 852.

Face seals 854 and 856 are at the same axial end of the filter as transverse gap 834. Face seal 854 transversely spans from one of the first and second sets of pleat tips of first filter portion 808 at least partially towards, and if desired all the way towards, the other of the first and second sets of pleat tips of first filter portion 808, and laterally spans adjacent channels of filter portion 808 to block axial flow through the area defined by the transverse and lateral span of face seal 854 including blocking flow through adjacent channels of filter portion 808 spanned by face seal 854. Face seal 856 transversely spans from one of the noted first and second sets of pleat tips of second filter portion 810 at least partially towards, and if desired all the way towards, the other of the first and second sets of pleat tips of second filter portion 810, and laterally spans adjacent channels of second filter portion 810 to block axial flow through the area defined by the transverse and lateral span of face seal 856 including blocking axial flow through adjacent channels of second filter portion 810 spanned by face seal 856. Transverse gap 834 is disposed transversely between face seals 854 and 856, which face seals permit axial flow therebetween through transverse gap 834.

Third and fourth face seals 858 and 860 are provided at the axial end of the filter opposite transverse gap 834 and first and second seals 854 and 856. Face seals 858 and 860 may be separate members or may be a combined unitary one-piece member as shown, and may also provide the above noted seal 836 comparable to seal 348 of FIG. 25. Face seal 858 transversely spans from one of the noted first and second sets of pleat tips of first filter portion 808 at least partially towards, and if desired all the way towards, the other of the first and second sets of pleat tips of first filter portion 808, and laterally spans adjacent channels of first filter portion 808 to block axial flow through the area defined by the transverse and lateral span of face seal 858 including blocking axial flow through adjacent channels spanned by face seal 858. Face seal 860 transversely spans from one of the noted first and second sets of pleat tips of second filter portion 810 at least partially towards, and if desired all the towards, the other of the first and second sets of pleat tips of second filter portion 810, and laterally spans adjacent channels of second filter portion 810 to block axial flow through the area defined by the transverse and lateral span of face seal 860 including blocking axial flow through adjacent channels spanned by face seal 860. The filter has a first sidewall portion 862, comparable to sidewall 338 of FIG. 25, transversely spaced from first filter portion 808 at axial end 804 by transverse gap 846, and permitting axial flow through such gap. The filter has a second sidewall portion 864, comparable to sidewall 340 of FIG. 25, transversely spaced from second filter portion 810 at axial end 804 by transverse gap 844, and permitting axial flow through gap 844.

In FIGS. 57-59, face seals 858 and 860 and transverse gaps 846 and 844 are at the upstream axial end of the filter, and face seals 854 and 856 and transverse gap 834 therebetween are at the downstream axial end. FIG. 60 shows reverse flow, wherein face seals 854 and 856 and transverse gap 834 therebetween are at the upstream axial end of the filter, and face seals 858 and 860 and transverse gaps 846 and 844 are at the downstream axial end.

FIGS. 61 and 62 use like reference numerals from above where appropriate to facilitate understanding, and show an alternate version of the filter of FIGS. 57-59. Face seals 858 and 860 of FIGS. 57-59 are replaced by respective face seals 858a and 860a, which may be separate or may be a single unitary one-piece member, having respective tapered ramp surfaces 866 and 868 directing incoming fluid flow axially and transversely as shown at respective arrows 870 and 872 toward transverse gaps 846 and 844, respectively.

FIGS. 63 and 64 use like reference numerals from above where appropriate to facilitate understanding, and show an alternate version of the filter of FIG. 60. Face seals 854 and 856 of FIGS. 57-59 are replaced by respective face seals 854a and 856a having respective tapered ramp surfaces 874 and 876 directing incoming fluid flow axially and transversely inwardly, as shown at respective arrows 878 and 880, toward transverse gap 834 therebetween.

In the embodiments of FIGS. 57-64, at least one, and preferably all of the noted face seals 854, 856, 858, 860, 858a, 860a, 854a, 856a, transversely span from one of the first and second sets of pleat tips of its respective filter portion 808 or 810 all the way to the other of the first and second sets of pleat tips of the respective filter portion, and laterally span all adjacent channels such that axial fluid flow is blocked at the respective face seal and instead must flow through a respective transverse gap 834, 846, 844.

In other embodiments, FIGS. 65, 66, one or more of the noted face seals transversely spans from one of the first and second sets of pleat tips of its respective filter portion only partially towards the other of the first and second sets of pleat tips of the respective filter portion, and one of the upstream and downstream axial ends 828 and 830 of the wall segments 814 of the respective filter portion are alternately sealed to each other, as above, at the respective axial end for the remainder of the transverse span from such face seal to the other of the first and second sets of pleat tips, to define a first set of flow channels along such remainder of the transverse span and having open ends, as above, and a second set of flow channels along the remainder of the transverse span interdigitated with the first set of flow channels and having closed ends, as above. For example, face seals 854 and 856 may be replaced by partial span face seals 854b and 856b, FIGS. 65, 66, and/or face seals 858 and 860 may be replaced by partial span face seals 858b and 860b. In one embodiment as shown in FIGS. 65, 66, each of the noted first through fourth face seals 854b, 856b, 858b, 860b, transversely spans from one of the first and second sets of pleat tips of its respective filter portion only partially towards the other of the first and second sets of pleat tips of its respective filter portion, and the upstream ends of the wall segments of each of the first and second filter portions 808 and 810 are alternately sealed to each other along the remainder of the transverse span from the respective face seal to the other of the first and second sets of pleat tips of the respective filter portion to define a first set of flow channels for each filter portion having open upstream ends along the remainder of the transverse span from the respective face seal to the other of the first and second sets of pleat tips of the respective filter portion, and a second set of flow channels along the remainder of the transverse span between the respective face seal and the other of the first and second sets of pleat tips of the respective filter portion and interdigitated with the first set of flow channels and having closed upstream ends, and wherein the downstream ends of the wall segments of each of the first and second filter portions 808 and 810 are alternately sealed to each other along the remainder of the transverse span from the respective face seal to the other of the first and second sets of pleat tips of the respective filter portion such that the first set of flow channels for each filter portion has closed downstream ends along the remainder of the transverse span from the respective face seal to the other of the first and second sets of pleat tips of the respective filter portion, and the second set of flow channels have open downstream ends along the remainder of the transverse span from the respective face seal to the other of the first and second sets of pleat tips of the respective filter portion.

The filters described in FIGS. 57-66 are panel filters, wherein each of the filter portions 808 and 810 is a panel filter element. In other embodiments, the filter is an annular filter, FIGS. 67-71, having a shape selected from the group consisting of a circle, an oval, a racetrack shape, an obround shape, and other closed-loop shapes, wherein the noted first and second filter portions such as 808 and 810 are arcuate portions around the circumference of the annulus. FIGS. 67, 68 show filter 800c with annular filter element 809 formed by arcuate filter portions 808c and 810c formed in a closed-loop annulus and having upstream face seals 858c, 860c, comparable to face seals 858, 860 of FIG. 58, and which may be a single unitary piece, and having downstream face seals 854c, 856c, comparable to face seals 854, 856 of FIG. 58, and which may a single unitary piece having a central aperture at 834c. Fluid flows axially as shown at arrows 850c, 848c, comparably to arrows 850, 848 of FIG. 58, into outer arcuate transverse gap portions 846c, 844c, comparable to gaps 846 and 844 of FIG. 58, then is filtered by passing through the filtering wall segments, and then exits as shown at arrow 852c, comparable to arrow 852 in FIG. 58, through transverse gap 834c, comparable to transverse gap 834 of FIG. 58.

FIG. 69 is like FIG. 67 and shows an alternate version comparably to FIG. 62, wherein face seals 858c and 860c of FIG. 67 are provided with tapered ramp surfaces 866c and 868c, comparable to tapered ramp surfaces 866 and 868 of FIGS. 61, 62.

FIGS. 70 and 71 show a further embodiment comparable to FIGS. 63 and 64 wherein face seals 854c and 856c of FIGS. 67, 68 are provided with tapered ramp surfaces 874c and 876c, comparable to tapered ramp surfaces 874 and 876 of FIGS. 63, 64.

The respective face seals described above may laterally span and close adjacent channels without an open channel therebetween at one or both of the upstream and downstream faces, as shown in FIGS. 57-64, 67-71, or the face seals may laterally span only some of the channels and have respective open channels therebetween, FIGS. 65, 66.

In the foregoing description, certain terms have been used for brevity, clearness, and understanding. No unnecessary limitations are to be implied therefrom beyond the requirement of the prior art because such terms are used for descriptive purposes and are intended to be broadly construed. The different configurations, systems, and method steps described herein may be used alone or in combination with other configurations, systems, and method steps. It is to be expected that various equivalents, alternatives and modifications are possible within the scope of the appended claims. The noted pleat tips and bend lines can be pointed or can be rounded or fluted. The above principles are applicable to various panel filters and to various annular filters of various closed-loop shapes, and to filters having stacked multiple filter elements.

### Present Application

FIG. 72 is a perspective view of one embodiment of a direct flow filter according to the present disclosure. The direct flow filter may be described with reference to an axial direction X, a transverse direction Y, and a lateral direction Z. The direct flow filter includes a pleat block 1000 comprising filter material and having a first pleated filter portion 1002 and a second pleated filter portion 1004. The first filter portion 1002 and second filter portion 1004 are coupled and may be folded together such that the pleat block has a V-shape configuration. As described herein, the first filter portion 1002 and second filter portion 1004 may be coupled by a portion of the filter material and the flexible strip. In other embodiments, the first filter portion 1002 and second filter portion 1004 may be coupled only by the flexible strip.

The first filter portion 1002 and second filter portion 1004 may be like those shown in 304, 306, FIG. 24, and 808, 810, FIG. 57, in that each portion has a plurality of pleats 1004, 1008, (such as 812, FIG. 58), defined by wall segments 1010, 1012, (such as 814, FIG. 58), extending along a transverse direction Y between first and second sets of pleat tips 1014, 1016, 1018, 1020, (such as 818, 820, FIG. 58), at first and second sets of axially extending bend lines 1022, 1024, 1026, 1028 (such as 822, 824, FIG. 58). Transverse direction Y is perpendicular to axial direction X. Each filter portion 1002, 1004 extends along a lateral direction Z perpendicular to axial direction X and transverse direction Y. Wall segments 1010, 1012 extend axially between first and second axial ends 1030, 1032, 1034, 1036, (such as 828, 830, FIG. 58). The wall segments define axial channels therebetween 1038, 1040 (such as 832, FIG. 57; 332, FIG. 24, and channels 55, FIG. 2). The channels have a channel width extending along a lateral direction Z between respective wall segments. The axially extending bend lines 1022, 1026 are coplanar and define a front face of the filter extending laterally and axially (which may be a downstream face or an upstream face depending upon direction of fluid flow). The axially extending bend lines 1024, 1028 are coplanar and define a back face of the filter extending laterally and axially (which may be an upstream face or a downstream face depending upon direction of fluid flow).

The direct flow filter includes a flexible joint 1042 coupling the first and second pleated filter portions. The joint includes a flexible strip 1044 extending from a top end 1046 of the front face of the filter to a bottom end 1048 of the front face of the filter in the lateral direction Z. In FIG. 72, the first and second pleated portions are partially separated by a slit 1050 which extends transversely through a portion of the wall segments and which creates a laterally extending center line through the back face of the pleat block. In FIG. 72, the first and second portions are partially separated and coupled by a portion of the wall segments. In other embodiments, the first and second filter portions may be completely separate portions not coupled by any portion of the wall segments (but coupled by the flexible strip).

The flexible strip 1044 is located on the front face opposite the center line defined by the slit 1050. In some embodiments, the flexible strip laterally spans all adjacent channels. As contemplated herein, the flexible strip may be applied to the first and second filter portions as a liquid adhesive material which subsequently sets to form a solid flexible strip, or alternately the flexible strip may be applied to the first and second filter portions as a solid material that is adhered to the first and second filter portions via an adhesive (e.g., via adhesive beads).

FIG. 73 provides a partial cross-sectional view through an axial and transverse plane of one embodiment of direct flow filter according to the present disclosure. In FIG. 73, the slit 1050 extends transversely through a portion of the wall segments 1010 and 1012 at a center line 1058 to partially separate the block into the first and second filter portions. In FIG. 73, the first and second portions are coupled by a portion of the wall segments 1052 which may provide a joint 1042. In other embodiments, the first and second filter portions may be completely separate portions coupled only by the flexible strip and adhesive beads.

FIG. 74 provides a partial cross-sectional view through an axial and transverse plane of another embodiment of a direct flow filter according to the present disclosure. Two adhesive beads 1054, 1056 (e.g., hot-melt beads) are located on the front face opposite the center line 1058 defined by the slit 1050. The adhesive beads extend parallel from a top end 1046 (FIG. 72) of the front face to a bottom end 1048 (FIG. 72) of the front face and may function as sealant beads for the filter. As contemplated herein, adhesive beads may include, but are not limited to, hot melt adhesive beads or other forms of adhesive material, such as adhesive silicone or other material that is cured via UV-radiation or other methods. The adhesive beads may flow and seal against the pleated media and fill voids or valleys between adjacent pleats.

FIG. 75 provides a partial cross-sectional view through an axial and transverse plane of another embodiment of the direct flow filter of FIG. 72. The flexible strip 1044 extends axially between and over the adhesive beads 1054, 1056. The flexible strip overlaps the adhesive beads axially (e.g., by approximately 1 bead width or by about 1 mm). The flexible strip typically extends axially over each bead to provide a impermeable seal with respect to fluid flow.

FIG. 76 provides a partial cross-sectional view through an axial and transverse plane of the direct flow filter of FIG. 75 folded into a V-shaped geometry. The first pleated portion and the second pleated portion form an angle a defined by the axial ends 1032, 1034 of the wall segments 1010, 1012 coupled at a joint 1042 that includes the two adhesive beads 1054, 1056, and the flexible strip 1044.

FIG. 77 provides a cross-sectional view through an axial and transverse plane of another embodiment of a direct flow filter having a V-shaped geometry. Two adhesive beads 1060, 1062 (e.g., hot-melt beads) are placed on the back face adjacent to exterior pleat tips 1064, 1066. The adhesive beads may flow and seal against the pleated media and fill voids or valleys between adjacent pleats. The two adhesive beads extend from a top end of the back face to a bottom end of the back face and may be utilized to attach the filter to a frame or housing (which terms may be utilized interchangeably herein). In some embodiments, the back face of the filter may be sealed to an interior wall of the frame. Optionally, the two adhesive beads are located at a position that is approximately 2-4 mm from the end of the pleat tips.

FIG. 78 provides a cross-sectional view through an axial and transverse plane of another embodiment of a direct flow filter having a V-shaped geometry of FIG. 77 and attached to a frame 1068. The two adhesive beads 1060, 1062 (FIG. 77) contact the frame at interior walls 1070, 1072, optionally at interior ledges 1074, 1076 on the interior walls.

FIG. 79 provides a cross-sectional view through an axial and transverse plane of another embodiment of a direct flow filter having a V-shaped geometry and attached to a frame 1068. The first pleated portion 1002 and the second pleated portion 1004 are coupled at an angle β, which may be any suitable angle (e.g., an acute angle such as an angle of 0-45°, 0-30°, or 0-15°). Unfiltered fluid 1078 (such as gas or liquid) enters the filter at upstream ends 1032, 1034, passes through the filter in an axial direction X, and exits the filter at downstream ends 1030, 1036. As discussed herein, filtered fluid may pass through the wall channels of the filter. The flexible seal 1044 is impermeable to the unfiltered fluid entering the filter at the upstream end and directs the unfiltered fluid into the channels of the first pleated portion and the second pleated portion.

FIG. 80 is an isometric front view of one embodiment of a direct flow filter. The filter includes a flexible seal 1044 extending axially over two adhesive beads 1054, 1056. FIG. 81 is an isometric front view of the direct flow filter of FIG. 80 in which the first filter portion and second filter portion have been folded together at an angle β, which is a supplementary angle to angle α. FIG. 82 is an isometric back view of the direct flow filter of FIG. 80 and illustrates adhesive beads 1060 and 1062 and slit 1050. The adhesive beads are applied to the back face and may flow and seal against the pleated media and fill voids or valleys between adjacent pleats.

In some embodiments, the disclosed direct flow filter may be manufactured as follows. A pleated media pack may be initially produced by scoring a filter media which is unwound from a roll and fed into a line. The filter media, which optionally is pre-slit, proceeds down the line to a set of rolls where it is scored as it passes simultaneously through male and female rolls (i.e., score rolls). The action of the rolls produces an indentation in the media perpendicular to the line of media travel. Lines are produced at intervals that represent approximately the desired pleat height.

The scored media then travels down the line to a point where four adhesive beads of material (e.g., hot-melt adhesive beads) are applied in two sets of two alternately to the front face and the back face of the media pack. Optionally, the adhesive beads may be foamed with an inert, dry gas such as nitrogen to reduce the density of the material to a range of about 0-75% (or to a range of about 30%-65%). Two of the four adhesive beads are applied 2 mm-4 mm from the outer most edge of the media on the upstream side (relative to fluid flow and media characteristics). The other two of the four adhesive beads are applied alternately on the downstream side of the media towards the center of the pack and are separated by a distance of approximately 5 mm-8 mm.

After having been contacted with the score rolls, the pleated media pack is mechanically perforated up to, and just short of every other score line. As such, the pleated pack includes a first and second portion that are coupled together yet separated enough to be folded into a V-shaped configuration

As the pleated media travels further down the line, a strip or ribbon of material is laid directly over the downstream beads at the center of the pack. This strip or ribbon is approximately 9 mm-14 mm wide, or just enough to fill the area between the existing seal beads and extend slightly beyond their location (i.e., overlap their location in an axial direction). It has an initial transverse thickness of 1 mm-5 mm and may comprise material such as a thermoplastic or thermoset hot melt, adhesive or sealant. Examples of suitable material for the strip or ribbon include polyamide or polyester material. In some embodiments, the strip or ribbon may be applied as a liquid which sets and forms a solid material (e.g., in less than about 60 seconds). In other embodiments, the strip or ribbon may be applied as a solid material which is adhered to the pack via an adhesive (e.g., via hot-melt adhesive beads). In solid form, the strip or ribbon is flexible and impermeable to the filtered fluid.

When the strip or ribbon is applied as a liquid material which sets, prior to setting the strip or ribbon may flow and seal against the pleated media and fill voids or valleys between adjacent pleats. Optionally, prior to setting, a device may flatten the strip or ribbon via a pressurized roll (or similar) against the pleated media. For example, the device may push the strip or ribbon into the media, filling voids or valleys between adjacent pleats and increasing the axial width of the originally applied strip or ribbon to approximately 10 mm-16 mm. These series of processes may create an integrated, flexible seal with a final transverse thickness of 0.25 mm-3.00 mm.

The strip or ribbon, which may be referred to herein alternatively as a sealant bead or a seal, is flexible and impermeable when solid. The material of the flexible seal may be foamed to reduce density and improve flexibility. For example, an adhesive sealant may be foamed from about 0-75% to form the material of the flexible seal. Suitable gases for foaming the material include inert, dry gases such as nitrogen.

The flexible seal may stabilize the pleat block during manufacturing and facilitate the manufacturing process. Furthermore, the flexible seal may add rigidity to the pleat block or to finished filter elements.

The flexible seal may serve as a source indicator for a filter product in order to identify counterfeit products. In some embodiments, the flexible seal may comprise a material of a different color than the material of the pleated filter block (e.g., a contrasting color).

In the foregoing description, certain terms have been used for brevity, clearness, and understanding. No unnecessary limitations are to be implied therefrom beyond the requirement of the prior art because such terms are used for descriptive purposes and are intended to be broadly construed. The different configurations, systems, and method steps described herein may be used alone or in combination with other configurations, systems, and method steps. It is to be expected that various equivalents, alternatives and modifications are possible within the scope of the appended claims. The noted pleat tips and bend lines can be pointed or can be rounded or fluted or of various geometries at the pleat tips. The above principles are applicable to various panel filters and to various annular filters of various closed-loop shapes, and to filters having stacked multiple filter elements.

1. A direct flow filter for filtering a fluid flowing along an axial flow direction from an upstream axial end to a downstream axial end, comprising first and second pleated filter portions each having a plurality of pleats defined by wall segments extending along a transverse direction between first and second sets of pleat tips at first and second sets of axially extending bend lines, the transverse direction being perpendicular to the axial direction, the wall segments extending axially between the upstream and downstream axial ends, the wall segments defining axial flow channels therebetween, the channels having a channel width extending along a lateral direction between respective wall segments, the lateral direction being perpendicular to the axial direction and perpendicular to the transverse direction, the axially extending bend lines defining a front face and a back face of the first and second pleated filter portions, the filter further comprising a flexible joint coupling the first and second pleated filter portions, the joint comprising;
(a) a flexible strip extending from a top end of the front face to a bottom end of the front face in the lateral direction, wherein the flexible strip forms an integrated seal that is not permeable to the flowing fluid; and
(b) a portion of the wall segments.

2. The direct flow filter of claim 1, wherein the joint permits the first and second portions to fold together at an angle.

3. The direct flow filter of claim 1, wherein the flexible strip is adhesively attached to the front face.

4. (canceled)

5. (canceled)

6. The direct flow filter of claim 1, further comprising two adhesive beads extending laterally from a top end of the front face to a bottom end of the front face adjacent to a center line wherein the flexible strip extends axially between the two adhesive beads.

7. The direct flow filter of claim 1, further comprising two adhesive beads extending laterally from a top end of the back face to a bottom end of the back face adjacent to exterior pleat tips.

8. The direct flow filter of claim 1, further comprising a frame wherein the pleated filter portions are attached to the frame.

9. The direct flow filter of claim 1, wherein the flexible strip comprises an adhesive material.

10. The direct flow filter of claim 1, wherein the flexible strip has a transverse thickness of about 0.25-3 mm and an axial width of about 10-16 mm.

11. A method for making the direct flow filter of claim 1, the method comprising:
(a) providing a pleated filter block comprising a plurality of pleats defined by wall segments extending along a transverse direction between a set of pleat tips at a set of axially extending bend lines, the transverse direction being perpendicular to the axial direction, the wall segments extending axially between the upstream and downstream axial ends, the wall segments defining axial flow channels therebetween, the channels having a channel width extending along a lateral direction between respective wall segments, the lateral direction being perpendicular to the axial direction and perpendicular to the transverse direction, the axially extending bend lines defining a front face and a back face of the first and second pleated filter portions,
(b) perforating the block transverse through a portion of the wall segments along the back face to create a slit which defines a center line extending laterally from a top end of the back face to bottom end of the back face, the slit separating a first portion of the block and a second portion of the block wherein the first portion and the second portion remain coupled by a portion of the wall segments; and
(c) applying a strip of material to the front face opposite the center line defined by the slit, wherein the strip extends laterally from a top end of the front face to a bottom end of the front face and the strip of material adheres to the front face.

12. The method of claim 11, wherein the strip of material is applied as a strip of liquid material which sets to form a strip of solid flexible material.

13. The method of claim 11, wherein the liquid material comprise an adhesive sealant.

14. The method of claim 11, wherein the strip of material is applied as a strip of solid flexible material which is adhered via adhesive beads.

15. The method of claim 11, further comprising folding the first portion of the block and the second portion of the block together along the center line to form an acute angle wherein the flexible strip is interior of the angle.

16. The method of claim 11, wherein the liquid material is foamed.

17. The method of claim 11, further comprising, prior to step (c), applying two adhesive beads extending from a top end of the front face to a bottom end of the front face in the lateral direction wherein the two adhesive beads form parallel lines that are centered on the block and the strip is applied between the two adhesive beads and the strip extends axially between and over the two adhesive beads.

18. The method of claim 11, wherein the strip has an axial width of 9-14 mm and a transverse thickness of 1-5 mm.

19. The method of claim 18, further comprising contacting the applied strip of liquid material with a device that flattens the strip prior to the strip setting as a solid material, and the flattened strip has an axial width of 10-16 mm and a transverse thickness of 0.25-3 mm.

20. The method of claim 11, wherein the strip comprises an adhesive material.

21. The method of claim 11, further comprising applying two adhesive beads extending from a top end of the back face to a bottom end of the back face in the lateral direction adjacent to exterior pleat tips of the block.

22. The method of claim 21, further comprising attaching the first portion and the second portion to a frame wherein the two adhesive beads seal the first portion and the second portion to the frame.
